(19) United States
(12) Patent Application Publication
(10) Pub. No.: US 2023/0252624 A1
(43) Pub. Date: Aug. 10, 2023

(54) POINT DETECTION SYSTEMS AND METHODS FOR OBJECT IDENTIFICATION AND TARGETING

(71) Applicant: Carbon Autonomous Robotic Systems Inc., Seattle, WA (US)

(72) Inventors: Alexander Igorevich SERGEEV, Newcastle, WA (US); Evan William BROSSARD, Seattle, WA (US); Raven PILLMANN, Seattle, WA (US); Zachary David NEW, Seattle, WA (US)

(21) Appl. No.: 18/098,542

(22) Filed: Jan. 18, 2023

Related U.S. Application Data
(60) Provisional application No. 63/306,904, filed on Feb. 4, 2022.

(51) Int. Cl. G06T 7/00; G06V 20/10; A01G 7/00

(52) U.S. Cl. CPC G06T 7/0012; G06V 20/188; A01G 7/00

(57) ABSTRACT

Described herein are systems and methods for identifying, tracking, evaluating, and targeting objects, such as plants, crops, weeds, pests, or surface irregularities. The methods described herein may include identifying an object on a surface, categorizing the object, identifying a type of plant, locating a point on the surface corresponding to a feature of the object, determining a size of the object and/or evaluating a condition of the object. Such methods may be implemented in various crop management techniques, such as autonomous weed eradication, pest management, crop management, or soil management.

### CROSS-REFERENCE

This application claims the benefit of U.S. Provisional Application No. 63/306,904, filed Feb. 4, 2022, which application is incorporated herein by reference.

### BACKGROUND

As technology advances, tasks that had previously been performed by humans are increasingly becoming automated. While tasks performed in highly controlled environments, such as factory assembly lines, can be automated by directing a machine to perform the task the same way each time, tasks performed in unpredictable environments, such as agricultural environments, depend on dynamic feedback and adaptation to perform the task. Autonomous systems often struggle to identify and locate objects in unpredictable environments. Improved methods of object tracking would advance automation technology and increase the ability of autonomous systems to react and adapt to unpredictable environments.

### SUMMARY

In various aspects, the present disclosure provides a computer-implemented method to detect a target plant, the computer-implemented method comprising: receiving an image of a region of a surface, the region comprising a target plant positioned on the surface; determining one or more parameters of the target plant, wherein the one or more parameters of the target plant includes a point location of the target plant; identifying the target plant in the image based on the one or more parameters of the target plant.

In some aspects, the region of a surface further comprises one or more additional plants. In some aspects, the target plant is a weed or a guest crop. In some aspects, the point location corresponds to a feature of the target plant. In some aspects, the feature is a center of the target plant, a meristem of the target plant, or a leaf of the target plant. In some aspects, the one or more parameters further comprise a plant location, a plant size, a plant category, a plant type, a leaf shape, a leaf arrangement, a plant posture, a plant health, or combinations thereof. In some aspects, the surface is an agricultural surface.

In some aspects, the point location comprises a location of a plant meristem, a centroid location, or a leaf location. In some aspects, the computer-implemented method further comprises targeting the target plant with an implement at the point location. In some aspects, the implement is a laser, a sprayer, or a grabber. In some aspects, the laser is an infrared laser. In some aspects, the computer-implemented method further comprises activating the implement for a duration of time at the point location. In some aspects, the duration of time is sufficient to kill the target plant. In some aspects, the duration of time is based on one or more properties of the target plant. In some aspects, the one or more properties comprise a plant size, a plant type, or both. In some aspects, the duration of time scales non-linearly with the plant size. In some aspects, the computer-implemented method comprises killing the target plant with the implement. In some aspects, the computer-implemented method comprises burning the feature of the target plant using the implement.

In some aspects, the computer-implemented method further comprises determining a plant size of the target plant. In some aspects, the plant size comprises a size of one or more structures of the target plant. In some aspects, the one or more structures is selected from the group consisting of a leaf, a stem, a blade, a flower, a fruit, a seed, a shoot, a bud, and combinations thereof. In some aspects, the plant size comprises a length, a radius, a diameter, an area, or any combination thereof.

In some aspects, the computer-implemented method further comprises classifying a plant type of the target plant. In some aspects, the plant type is based on a leaf shape of the target plant. In some aspects, the plant type is selected from the group consisting of a crop, a weed, a grass, a broadleaf, a purslane, or combinations thereof. In some aspects, the computer-implemented method further comprises assessing a condition of the target plant. In some aspects, the condition comprises health, maturity, nutrition state, disease state, ripeness, crop yield, or any combination thereof. In some aspects, the computer-implemented method further comprises determining a confidence score for the one or more parameters. In some aspects, the computer-implemented method further comprises scheduling the target plant to be targeted based on the confidence score.

In some aspects, the computer-implemented method further comprises obtaining labeled image data comprising parameterized objects corresponding to similar plants. In some aspects, the computer-implemented method further comprises training a machine learning model to identify parameters corresponding to target plants, wherein the machine learning model is trained using the labeled image data. In some aspects, the computer-implemented method further comprises generating a plant prediction corresponding to the one or more parameters of the target plant, wherein the one or more parameters of the target plant includes a point location of the target plant, and wherein the one or more parameters are identified by using the image as input to the machine learning model. In some aspects, the computer-implemented method further comprises updating the machine learning model using the image, the one or more parameters, and information corresponding to identification of the target plant, wherein when the machine learning model is updated, the machine learning model is used to identify new object parameters from new images.

In some aspects, updating the machine learning model comprises receiving additional labeled image data comprising the image and fine-tuning the machine learning model based on the additional labeled image data. In some aspects, fine-tuning the machine learning model is performed with an image batch comprising a subset of the additional labeled image data and a subset of the labeled image data. In some aspects, fine-tuning the machine learning model is performed using fewer batches, fewer epochs, or fewer batches and fewer epochs than training the machine learning model.

In some aspects, the labeled image data comprises images of plants. In some aspects, the images of plants comprise images of weeds, images of crops, images of weeds and crops, or combinations thereof. In some aspects, the images of weeds comprise images of purslane weeds, images of broadleaf weeds, images of offshoots, images of grasses, or combinations thereof. In some aspects, the images of crops comprise images of onions, images of strawberries, images of carrots, images of corn, images of soybeans, images of barley, images of oats, images of wheat, images of alfalfa, images of cotton, images of hay, images of tobacco, images of rice, images of sorghum, images of tomatoes, images of potatoes, images of grapes, images of rice, images of lettuce, images of beans, images of peas, images of sugar beets, or combinations thereof. In some aspects, the images of plants are labeled with plant centroid location, meristem location, plant size, plant category, plant type, leaf shape, number of leaves, leaf arrangement, plant posture, plant health, or combinations thereof. In some aspects, the parameterized objects comprise data corresponding to point location, shape, size, category, type, or combinations thereof.

In some aspects, the computer-implemented method further comprises using a trained classifier to identify the target plant. In some aspects, the computer-implemented method further comprises using a trained classifier to locate a feature of the target plant. In some aspects, the trained classifier is trained using a training data set comprising labeled images. In some aspects, the labeled images are labeled with plant category, meristem location, plant size, plant condition, plant type, or any combination thereof.

In some aspects, the computer-implemented method further comprises pretraining the machine learning model. In some aspects, pretraining the machine learning model is performed with a pretraining dataset comprising the labeled image data and pretraining labeled image data sharing a common feature the labeled image data. In some aspects, the common feature is images of plants.

In various aspects, the present disclosure provides a computer-implemented method to detect a target object, the computer-implemented method comprising: receiving an image of a region of a surface, the region comprising a target object positioned on the surface; obtaining labeled image data comprising parameterized objects corresponding to similarly positioned objects; training a machine learning model to identify object parameters corresponding to target objects, wherein the machine learning model is trained using the labeled image data; generating an object prediction corresponding to one or more parameters of the target object, wherein the one or more object parameters of the target object includes a point location of the target object, and wherein the one or more object parameters are identified by using the image as input to the machine learning model; identifying the target object in the image based on the one or more parameters; and updating the machine learning model using the image, the one or more parameters, and information corresponding to identification of the target object, wherein when the machine learning model is updated, the machine learning model is used to identify new object parameters from new images.

In some aspects, the target object is a target plant, a pest, a surface irregularity, or a piece of equipment. In some aspects, the target plant is a weed or a guest crop. In some aspects, the surface irregularity is a rock, a soil chunk, or a soil additive. In some aspects, the piece of equipment is a sprinkler, a hose, or a marker. In some aspects, the pest is an insect, a bug, an arthropod, a spider, a fungus, or a nematode.

In some aspects, the labeled image data comprises images of plants. In some aspects, the images of plants comprise images of weeds, images of crops, or combinations thereof. In some aspects, the images of weeds comprise images of purslane weeds, images of broadleaf weeds, images of offshoots, images of grasses, or combinations thereof. In some aspects, the images of crops comprise images of onions, images of strawberries, images of carrots, images of corn, images of soybeans, images of barley, images of oats, images of wheat, images of alfalfa, images of cotton, images of hay, images of tobacco, images of rice, images of sorghum, images of tomatoes, images of potatoes, images of grapes, images of rice, images of lettuce, images of beans, images of peas, images of sugar beets, or combinations thereof. In some aspects, the images of plants are labeled with plant centroid location, meristem location, plant size, plant category, plant type, leaf shape, number of leaves, leaf arrangement, plant posture, plant health, or combinations thereof.

In some aspects, the one or more object parameters further comprise an object location, an object size, an object category, a plant type, leaf shape, leaf arrangement, plant posture, plant health, or combinations thereof. In some aspects, the surface is an agricultural surface.

In some aspects, the parameterized objects comprise data corresponding to point location, shape, size, category, type, or combinations thereof. In some aspects, the point location comprises a location of a plant meristem, a centroid location, or a leaf location. In some aspects, the computer-implemented method further comprises using a trained classifier to identify the target object. In some aspects, the computer-implemented method further comprises using a trained classifier to locate a feature of the target object. In some aspects, the trained classifier is trained using a training data set comprising labeled images. In some aspects, the labeled images are labeled with object category, meristem location, plant size, plant condition, plant type, or any combination thereof.

In some aspects, updating the machine learning model comprises receiving additional labeled image data comprising the image and fine-tuning the machine learning model based on the additional labeled image data. In some aspects, fine-tuning the machine learning model is performed with an image batch comprising a subset of the additional labeled image data and a subset of the labeled image data. In some aspects, fine-tuning the machine learning model is performed using fewer batches, fewer epochs, or fewer batches and fewer epochs than training the machine learning model.

In some aspects, the computer-implemented method further comprises pretraining the machine learning model. In some aspects, pretraining the machine learning model is performed with a pretraining dataset comprising the labeled image data and pretraining labeled image data sharing a common feature the labeled image data. In some aspects, the common feature is images of plants.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an isometric view of an autonomous laser weed eradication vehicle, in accordance with one or more embodiments herein;

FIG. 2 illustrates a top view of an autonomous laser weed eradication vehicle navigating a field of crops while implementing various techniques described herein;

FIG. 3 illustrates a side view of a detection system positioned on an autonomous laser weed eradication vehicle, in accordance with one or more embodiments herein;

FIG. 4 shows an image of a plant with the meristem located and the leaf radius measured, in accordance with one or more embodiments herein;

FIG. 5 shows images of weeds with the meristems located and the leaf radii measured, in accordance with one or more embodiments herein;

FIG. 6 illustrates an architecture of a point detection system, in accordance with one or more embodiments herein;

FIG. 7A illustrates a bounding region-based plant detection method;

FIG. 7B illustrates a mask-based plant detection method;

FIG. 8 is a block diagram illustrating components of a detection terminal in accordance with embodiments of the present disclosure;

FIG. 9 is an exemplary block diagram of a computing device architecture of a computing device which can implement the various techniques described herein;

FIG. 10 is a flow diagram illustrating a method of training and using a point detection module in accordance with embodiments of the present disclosure; and

FIG. 11 is a block diagram depicting components of a prediction system and a targeting system for identifying, locating, targeting, and manipulating an object, in accordance with one or more embodiments herein.

### DETAILED DESCRIPTION

Various example embodiments of the disclosure are discussed in detail below. While specific implementations are discussed, it should be understood that this description is for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the example embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example can be integrated with or used with any other feature of any other example.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various example embodiments given in this specification.

Without intent to limit the scope of the disclosure, examples of instruments, apparatus, methods, and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

Described herein are systems and methods for identifying and locating objects, such as plants or pests, on a surface, such as an agricultural field. The systems and methods of the present disclosure may be used to identify and precisely target plants, such as weeds, for use in various crop management methods. For example, an autonomous weed eradication system implementing a point detection method may be used to identify a weed, locate the meristem of the weed, and precisely target the meristem for weed eradication. A point detection method, as described herein, may be used to locate objects (e.g., plants, pests, equipment, surface irregularities, etc.) within an image (e.g., an image of an agricultural field), distinguish the objects by object category (e.g., as weeds or crops), determine a type and size of each object, and precisely locate features of the object (e.g., a plant meristem, a plant leaf, or the center of a plant). Additionally, a point detection method may be used to count objects of a particular category, locate crop rows, or assess plant health, nutrition, or maturity. A targeting system, such as the autonomous weed eradication systems described herein, may target the object feature (e.g., the plant meristem or the center of the plant), for example using an infrared laser, for a duration of time based on one or more parameters of the object (e.g., size, type, maturity, health, or nutrition).

As used herein, an “image” may refer to a representation of a region or object. For example, an image may be a visual representation of a region or object formed by electromagnetic radiation (e.g., light, x-rays, microwaves, or radio waves) scattered off of the region or object. In another example, an image may be a point cloud model formed by a light detection and ranging (LIDAR) or a radio detection and ranging (RADAR) sensor. In another example, an image may be a sonogram produced by detecting sonic, infrasonic, or ultrasonic waves reflected off of the region or object. As used herein, “imaging” may be used to describe a process of collecting or producing a representation (e.g., an image) of a region or an object.

As used herein a position, such as a position of an object or a position of a sensor, may be expressed relative to a frame of reference. Exemplary frames of reference include a surface frame of reference, a vehicle frame of reference, a sensor frame of reference, or an actuator frame of reference. Positions may be readily converted between frames of reference, for example by using a conversion factor or a calibration model. While a position, a change in position, or an offset may be expressed in a one frame of reference, it should be understood that the position, change in position, or offset may be expressed in any frame of reference or may be readily converted between frames of reference.

As used herein, a “sensor” may refer to a device capable of detecting or measuring an event, a change in an environment, or a physical property. For example, a sensor may detect light, such as visible, ultraviolet, or infrared light, and generate an image. Examples of sensors include cameras (e.g., a charge-coupled device (CCD) camera or a complementary metal-oxide-semiconductor (CMOS) camera), a LIDAR detector, an infrared sensor, an ultraviolet sensor, or an x-ray detector.

As used herein, “object” may refer to an item or a distinguishable area that may be observed, tracked, manipulated, or targeted. For example, an object may be a plant, such as a crop or a weed. In another example, an object may be a piece of debris. In another example, an object may be a distinguishable region or point on a surface, such as a marking or surface irregularity.

As used herein, “targeting” or “aiming” may refer to pointing or directing a device or action toward a particular location or object. For example, targeting an object may comprise pointing a sensor (e.g., a camera) or implement (e.g., a laser) toward the object. Targeting or aiming may be dynamic, such that the device or action follows an object moving relative to the targeting system. For example, a device positioned on a moving vehicle may dynamically target or aim at an object located on the ground by following the object as the vehicle moves relative to the ground.

As used herein, a “weed” may refer to an unwanted plant, such as a plant of an unwanted type or a plant growing in an undesirable place or at an undesirable time. For example, a weed may be a wild or invasive plant. In another example, a weed may be a plant within a field of cultivated crops that is not the cultivated species. In another example, a weed may be a plant growing outside of or between cultivated rows of crops.

As used herein, “manipulating” an object may refer to performing an action on, interacting with, or altering the state of an object. For example, manipulating may comprise irradiating, illuminating, heating, burning, killing, moving, lifting, grabbing, spraying, or otherwise modifying an object.

As used herein, “electromagnetic radiation” may refer to radiation from across the electromagnetic spectrum. Electromagnetic radiation may include, but is not limited to, visible light, infrared light, ultraviolet light, radio waves, gamma rays, or microwaves.

### Autonomous Weed Eradication Systems

The detection methods described herein may be implemented by an autonomous weed eradication system to target and eliminate weeds. Such detection methods may facilitate object identification and tracking. For example, an autonomous weed eradication system may be used to detect and locate a weed of interest identified in images or representations collected by a first sensor, such as a prediction sensor, over time relative to the autonomous weed eradication system. The detection information may be used to determine a predicted location of the weed relative to the system. The autonomous weed eradication system may then locate the same weed in an image or representation collected by a second sensor, such as a targeting sensor, using the predicted location. In some embodiments, the first sensor is a prediction camera, and the second sensor is a targeting camera. One or both of the first sensor and the second sensor may be moving relative to the weed. For example, the prediction camera may be coupled to and moving with the autonomous weed eradication system.

Targeting the weed may comprise precisely locating the weed using the targeting sensor, targeting the weed with a laser, and eradicating the weed by burning it with laser light, such as infrared light. The prediction sensor may be part of a prediction module configured to determine a predicted location of an object of interest, and the targeting sensor may be part of a targeting module configured to refine the predicted location of the object of interest to determine a target location and target the object of interest with the laser at the target location. The prediction module may be configured to communicate with the targeting module to coordinate a camera handoff using point to point targeting, as described herein. The targeting module may target the object at the predicted location. In some embodiments, the targeting module may use the trajectory of the object to dynamically target the object while the system is in motion such that the position of the targeting sensor, the laser, or both is adjusted to maintain the target.

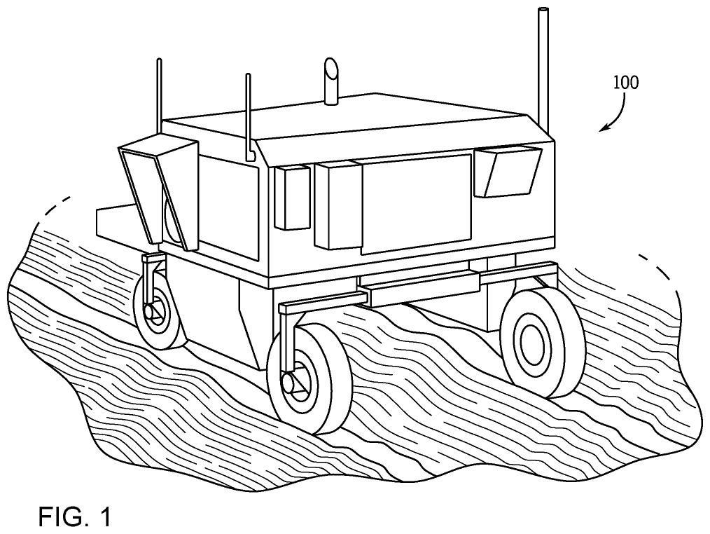

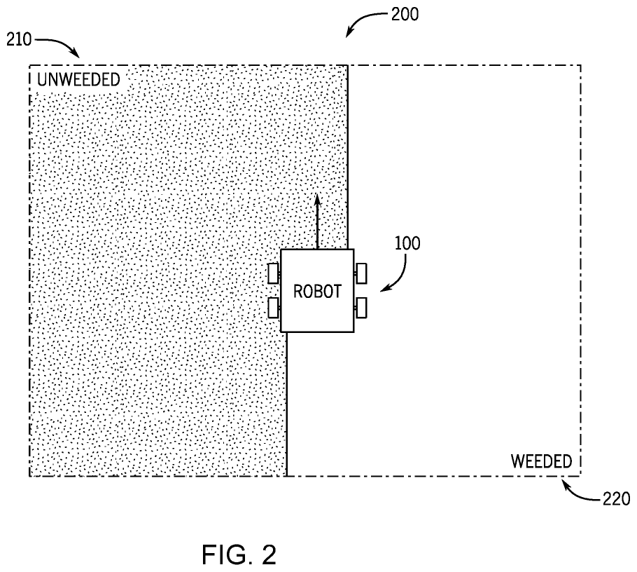

An autonomous weed eradication system may identify, target, and eliminate weeds without human input. Optionally, the autonomous weed eradication system may be positioned on a self-driving vehicle or a piloted vehicle or may be pulled by a vehicle such as a tractor. As illustrated in FIG. 1, an autonomous weed eradication system may be part of or coupled to a vehicle 100, such as a tractor or self-driving vehicle. The vehicle 100 may drive through a field of crops 200, as illustrated in FIG. 2. As the vehicle 100 drives through the field 200 it may identify, target, and eradicate weeds in an unweeded section 210 of the field, leaving a weeded field 220 behind it. The detection methods described herein may be implemented by the autonomous weed eradication system to identify, target, and eradicate weeds while the vehicle 100 is in motion. The high precision of such tracking methods enables accurate targeting of weeds, such as with a laser, to eradicate the weeds without damaging nearby crops.

### Detection Systems

In some embodiments, the detection methods described herein may be performed by a detection system. The detection system may comprise a prediction system and, optionally, a targeting system. In some embodiments, the detection system may be positioned on or coupled to a vehicle, such as a self-driving weeding vehicle or a laser weeding system pulled by a tractor. The prediction system may comprise a prediction sensor configured to image a region of interest, and the targeting system may comprise a targeting sensor configured to image a portion of the region of interest. Imaging may comprise collecting a representation (e.g., an image) of the region of interest or the portion of the region of interest. In some embodiments, the prediction system may comprise a plurality of prediction sensors, enabling coverage of a larger region of interest. In some embodiments, the targeting system may comprise a plurality of targeting sensors.

The region of interest may correspond to a region of overlap between the targeting sensor field of view and the prediction sensor field of view. Such overlap may be contemporaneous or may be temporally separated. For example, the prediction sensor field of view encompasses the region of interest at a first time and the targeting sensor field of view encompasses the region of interest at a second time but not at the first time. Optionally, the detection system may move relative to the region of interest between the first time and the second time, facilitating temporally separated overlap of the prediction sensor field of view and the targeting sensor field of view.

In some embodiments the prediction sensor may have a wider field of view than the targeting sensor. The prediction system may further comprise an object identification module to identify an object of interest in a prediction image or representation collected by the prediction sensor. The object identification module may differentiate an object of interest from other objects in the prediction image.

The prediction module may determine a predicted location of the object of interest and may send the predicted location to the targeting system. The predicted location of the object may be determined using the object tracking methods described herein.

The targeting system may point the targeting sensor toward a desired portion of the region of interest predicted to contain the object, based on the predicted location received from the prediction system. In some embodiments, the targeting module may direct an implement toward the object. In some embodiments, the implement may perform an action on or manipulate the object. In some embodiments, the targeting module may use the trajectory of the object to dynamically target the object while the system is in motion such that the position of the targeting sensor, the implement, or both is adjusted to maintain the target.

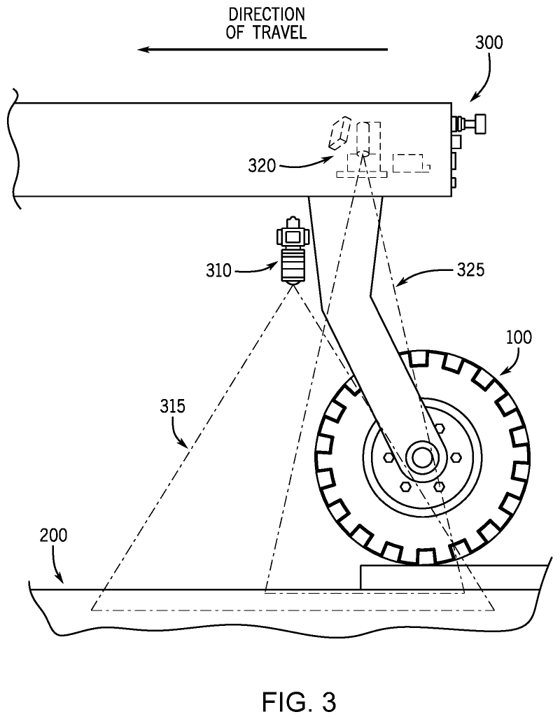

An example of a detection system 300 is provided in FIG. 3. The detection system may be part of or coupled to a vehicle 100, such as a self-driving weeding vehicle or a laser weeding system pulled by a tractor, that moves along a surface, such as a crop field 200. The detection system 300 includes a prediction module 310, including a prediction sensor with a prediction field of view 315, and a targeting module 320, including a targeting sensor with a targeting field of view 325. The targeting module may further include an implement, such as a laser, with a target area that overlaps with the targeting field of view 325. In some embodiments, the prediction module 310 is positioned ahead of the targeting module 320, along the direction of travel of the vehicle 100, such that the targeting field of view 325 overlaps with the prediction field of view 315 with a temporal delay. For example, the prediction field of view 315 at a first time may overlap with the targeting field of view 325 at a second time. In some embodiments, the prediction field of view 315 at the first time may not overlap with the targeting field of view 325 at the first time.

A detection system of the present disclosure may be used to target objects on a surface, such as the ground, a dirt surface, a floor, a wall, an agricultural surface (e.g., a field), a lawn, a road, a mound, a pile, or a pit. In some embodiments, the surface may be a non-planar surface, such as uneven ground, uneven terrain, or a textured floor. For example, the surface may be uneven ground at a construction site, in an agricultural field, or in a mining tunnel, or the surface may be uneven terrain containing fields, roads, forests, hills, mountains, houses, or buildings. The detection systems described herein may locate an object on a non-planar surface more accurately, faster, or within a larger area than a single sensor system or a system lacking an object matching module.

Alternatively or in addition, a detection system may be used to target objects that may be spaced from the surface they are resting on, such as a tree top distanced from its grounding point, and/or to target objects that may be locatable relative to a surface, for example, relative to a ground surface in air or in the atmosphere. In addition, a detection system may be used to target objects that may be moving relative to a surface, for example, a vehicle, an animal, a human, or a flying object.

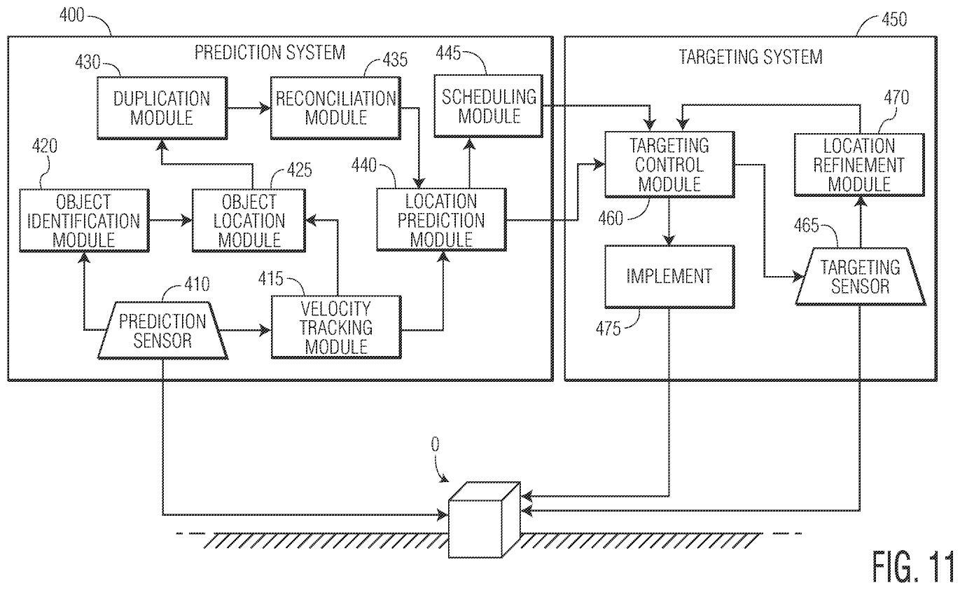

FIG. 11 illustrates a detection system comprising a prediction system 400 and a targeting system 450 for tracking at targeting an object O relative to a moving body, such as vehicle 100 illustrated in FIG. 1-FIG. 3. The prediction system 400, the targeting system 450, or both may be positioned on or coupled to the moving body (e.g., the moving vehicle). The prediction system 400 may comprise a prediction sensor 410 configured to image a region, such as a region of a surface, containing one or more objects, including object O. Optionally, the prediction system 400 may include a velocity tracking module 415. The velocity tracking module may estimate a velocity of the moving body relative to the region (e.g., the surface). In some embodiments, the velocity tracking module 415 may comprise a device to measure the displacement of the moving body over time, such as a rotary encoder. Alternatively or in addition, the velocity tracking module may use images collected by the prediction sensor 400 to estimate the velocity using optical flow.

The object identification module 420 may identify objects in images collected by the prediction sensor. For example, the object identification module 420 may identify weeds in an image and may differentiate the weeds from other plants in the image, such as crops. The object location module 425 may determine locations of the objects identified by the object identification module 420 and to compile a set of identified objects and their corresponding locations. Object identification and object location may be performed on a series of images collected by the prediction sensor 410 over time. The set of identified objects and corresponding locations from in two or more images from the object location module 425 may be sent to the deduplication module 430.

The deduplication module 430 may use object locations in a first image collected at a first time and object locations in a second image collected at a second time to identify objects, such as object O, appearing in both the first image and the second image. The set of identified objects and corresponding locations may be deduplicated by the deduplication module 430 by assigning locations of an object appearing in both the first image and the second image to the same object O. In some embodiments, the deduplication module 430 may use a velocity estimate from the velocity tracking module 415 to identify corresponding objects appearing in both images. The resulting deduplicated set of identified objects may contain unique objects, each of which has one or more corresponding locations determined at one or more time points. The reconciliation module 435 may receive the deduplicated set of objects from the deduplication module 430 and may reconcile the deduplicated set by removing objects. In some embodiments, objects may be removed if they are no longer being tracked. For example, an object may be removed if it has not been identified in a predetermined number of images in the series of images. In another example, an object may be removed if it has not been identified in a predetermined period of time. In some embodiments, objects no longer appearing in images collected by the prediction sensor 410 may continue to be tracked. For example, an object may continue to be tracked if it is expected to be within the prediction field of view based on the predicted location of the object. In another example, an object may continue to be tracked if it is expected to be within range of a targeting system based on the predicted location of the object. The reconciliation module 435 may provide the reconciled set of objects to the location prediction module 440.

The location prediction module 440 may determine a predicted location at a future time of object O from the reconciled set of objects. In some embodiments, the predicted location may be determined from two or more corresponding locations determined from images collected at two or more time points or from a single location combined with velocity information from the velocity tracking module 415. The predicted location of object O may be based on a vector velocity, including speed and direction, of object O relative to the moving body between the location of object O in a first image collected at a first time and the location of object O in a second image collected at a second time. Optionally, the vector velocity may account for a distance of the object O from the moving body along the imaging axis (e.g., a height or elevation of the object relative to the surface). Alternatively or in addition, the predicted location of the object may be based on the location of object O in the first image or in the second image and a vector velocity of the vehicle determined by the from the velocity tracking module 415.

The targeting system 450 may receive the predicted location of the object O at a future time from the prediction system 400 and may use the predicted location to precisely target the object with an implement 475 at the future time. The targeting control module 460 of the targeting system 450 may receive the predicted location of object O from the location prediction module 440 of the prediction system 435 and may instruct the targeting sensor 465, the implement 475, or both to point toward the predicted location of the object. Optionally, the targeting sensor 465 may collect an image of object O, and the location refinement module 470 may refine the predicted location of object O based on the location of object O determined from the image. In some embodiments, the location refinement module 470 may account for optical distortions in images collected by the prediction sensor 410 or the targeting sensor 465, or for distortions in angular motions of the implement 475 or the targeting sensor 465 due to nonlinearity of the angular motions relative to object O. The targeting control module 460 may instruct the implement 475, and optionally the targeting sensor 465, to point toward the refined location of object O. In some embodiments, the targeting control module 460 may adjust the position of the targeting sensor 465 or the implement 475 to follow the object to account for motion of the vehicle while targeting. The implement 475, such as a laser, may then manipulate object O. For example, a laser may direct infrared light toward the predicted or refined location of object O. Object O may be a weed and directing infrared light toward the location of the weed may eradicate the weed.

In some embodiments, a prediction system 400 may further comprise a scheduling module 445. The scheduling module 445 may select objects identified by prediction module and schedule which ones to target with the targeting system. The scheduling module 445 may schedule objects for targeting based on parameters such as object location, relative velocity, implement activation time, confidence score, weed type, or combinations thereof. For example, the scheduling module 445 may prioritize targeting objects predicted to move out of a field of view of a prediction sensor or a targeting sensor or out of range of an implement. Alternatively or in addition, a scheduling module 445 may prioritize targeting objects identified or located with high confidence. Alternatively or in addition, a scheduling module 445 may prioritize targeting objects with short activation times. In some embodiments, a scheduling module 445 may prioritize targeting objects based on a user's preferred parameters.

### Prediction Modules

A prediction module of the present disclosure may be configured to detect objects using the detection methods described herein. In some embodiments, a prediction module is configured to capture an image or representation of a region of a surface using the prediction camera or prediction sensor, identify an object of interest in the image, and determine a predicted location of the object.

The prediction module may include an object identification module configured to identify an object of interest and differentiate the object of interest from other objects in the prediction image. In some embodiments, the prediction module uses a machine learning model to identify and differentiate objects based on features extracted from a training dataset comprising labeled images of objects. For example, the machine learning model of or associated with the object identification module may be trained to identify weeds and differentiate weeds from other plants, such as crops. In another example, the machine learning model of or associated with the object identification module may be trained to identify debris and differentiate debris from other objects. The object identification module may be configured to identify a plant and to differentiate between different plants, such as between a crop and a weed. In some embodiments, the machine learning model may be a deep learning model, such as a deep learning neural network.

The machine learning model may be trained using supervised, unsupervised, reinforcement, or other such training techniques. For example, a set of images, which may or may not include various objects, may be analyzed using one of a variety of machine learning models to identify correlations between different elements of the images and particular objects without supervision and feedback (e.g., an unsupervised training technique). The machine learning model may also be trained using sample, live, or labeled images to identify objects within prediction or target images. As an example of a supervised training technique, a set of labeled images can be selected for training of the machine learning model to facilitate identification classification of these objects. The machine learning model may be evaluated to determine, based on the sample images supplied to the machine learning model, whether the machine learning model is accurately identifying and classifying objects within these images. Based on this evaluation, the machine learning model may be modified to increase the likelihood of the machine learning model accurately identifying and classifying objects within prediction and/or target images. The machine learning model may further be dynamically trained by soliciting feedback from users as to the accuracy of the machine learning model in identifying and classifying objects (i.e., the supervision). The feedback may be used to further train the machine learning model to provide more accurate results over time.

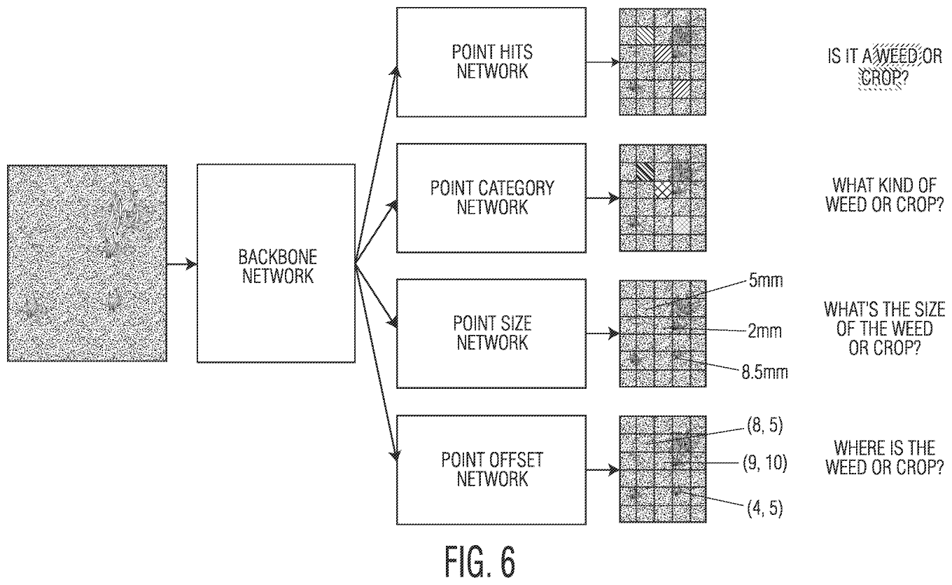

In some embodiments, the object identification module comprises using an identification machine learning model, such as a convolutional neural network. For example, the object identification module may comprise a point detection model (e.g., a point detection model illustrated in FIG. 6). The identification machine learning model may be trained with many images, such as high-resolution images, for example of surfaces with or without objects of interest. For example, the machine learning model may be trained with images of fields with or without weeds. Once trained, the machine learning model may be configured to identify a region in the image containing an object of interest. The region may be defined by a polygon, for example a rectangle. In some embodiments, the region is a bounding box. In some embodiments, the region is a polygon mask covering an identified region. In some embodiments, the identification machine learning model may be trained to determine a location of the object of interest, for example a pixel location within a prediction image.

The prediction module may further comprise a velocity tracking module to determine the velocity of a vehicle to which the prediction module is coupled. In some embodiments, the positioning system and the detection system may be positioned on the vehicle. Alternatively or in addition, the positioning system may be positioned on a vehicle that is spatially coupled to the detection system. For example, the positioning system may be located on a vehicle pulling the detection system. The velocity tracking module may comprise a positioning system, for example a wheel encoder or rotary encoder, an Inertial Measurement Unit (IMU), a Global Positioning System (GPS), a ranging sensor (e.g., laser, SONAR, or RADAR), or an Internal Navigation System (INS). For example, a wheel encoder in communication with a wheel of the vehicle may estimate a velocity or a distance traveled based on angular frequency, rotational frequency, rotation angle, or number of wheel rotations. In some embodiments, the velocity tracking module may utilize images from the prediction sensor to determine the velocity of the vehicle using optical flow.

The prediction module may comprise a system controller, for example a system computer having storage, random access memory (RAM), a central processing unit (CPU), and a graphics processing unit (GPU). The system computer may comprise a tensor processing unit (TPU). The system computer should comprise sufficient RAM, storage space, CPU power, and GPU power to perform operations to detect and identify a target. The prediction sensor should provide images of sufficient resolution on which to perform operations to detect and identify an object. In some embodiments, the prediction sensor may be a camera, such as a charge-coupled device (CCD) camera or a complementary metal-oxide-semiconductor (CMOS) camera, a LIDAR detector, an infrared sensor, an ultraviolet sensor, an x-ray detector, or any other sensor capable of generating an image.

### Targeting Modules

A targeting module of the present disclosure may be configured to target an object detected by a prediction module. In some embodiments, the targeting module may direct an implement toward the object to manipulate the object. For example, the targeting module may be configured to direct a laser beam toward a weed to burn the weed. In another example, the targeting module may be configured to direct a grabbing tool to grab the object. In another example, the targeting module may direct a spraying tool to spray fluid at the object. In some embodiments, the object may be a weed, a plant, an insect, a pest, a field, a piece of debris, an obstruction, a region of a surface, or any other object that may be manipulated. The targeting module may be configured to receive a predicted location of an object of interest from the prediction module and point the targeting camera or targeting sensor toward the predicted location. In some embodiments, the targeting module may direct an implement, such as a laser, toward the predicted location. The position of the targeting sensor and the position of the implement may be coupled. In some embodiments, a plurality of targeting modules are in communication with the prediction module.

The targeting module may comprise a targeting control module. In some embodiments, the targeting control module may control the targeting sensor, the implement, or both. In some embodiments, the targeting control module may comprise an optical control system comprising optical components configured to control an optical path (e.g., a laser beam path or a camera imaging path). The targeting control module may comprise software-driven electrical components capable of controlling activation and deactivation of the implement. Activation or deactivation may depend on the presence or absence of an object as detected by the targeting camera. Activation or deactivation may depend on the position of the implement relative to the target object location. In some embodiments, the targeting control module may activate the implement, such as a laser emitter, when an object is identified and located by the prediction system. In some embodiments, the targeting control module may activate the implement when the range or target area of the implement is positioned to overlap with the target object location.

The targeting control module may deactivate the implement once the object has been manipulated, such as grabbed, sprayed, burned, or irradiated; the region comprising the object has been targeted with the implement; the object is no longer identified by the target prediction module; a designated period of time has elapsed; or any combination thereof. For example, the targeting control module may deactivate the emitter once a region on the surface comprising a weed has been scanned by the beam, once the weed has been irradiated or burned, or once the beam has been activated for a pre-determined period of time.

The prediction modules and the targeting modules described herein may be used in combination to locate, identify, and target an object with an implement. The targeting control module may comprise an optical control system as described herein. The prediction module and the targeting module may be in communication, for example electrical or digital communication. In some embodiments, the prediction module and the targeting module are directly or indirectly coupled. For example, the prediction module and the targeting module may be coupled to a support structure. In some embodiments, the prediction module and the targeting module are configured on or coupled to a vehicle, such as the vehicle shown in FIG. 1 and FIG. 2. For example, the prediction module and the targeting module may be positioned on a self-driving vehicle. In another example, the prediction module and the targeting module may be pulled by a vehicle, such as a tractor.

The targeting module may comprise a system controller, for example a system computer having storage, random access memory (RAM), a central processing unit (CPU), and a graphics processing unit (GPU). The system computer may comprise a tensor processing unit (TPU). The system computer should comprise sufficient RAM, storage space, CPU power, and GPU power to perform operations to detect and identify a target. The targeting sensor should provide images of sufficient resolution on which to perform operations to match an object to an object identified in a prediction image.

### Optical Control Systems

The methods described herein may be implemented by an optical control system, such as a laser optical system, to target an object of interest. For example, an optical system may be used to target an object of interest identified in an image or representation collected by a first sensor, such as a prediction sensor, and locate the same object in an image or representation collected by a second sensor, such as a targeting sensor. In some embodiments, the first sensor is a prediction camera, and the second sensor is a targeting camera. Targeting the object may comprise precisely locating the object using the targeting sensor and targeting the object with an implement.

Described herein are optical control systems for directing a beam, for example a light beam, toward a target location on a surface, such as a location of an object of interest. In some embodiments, the implement is a laser. However, other implements are within the scope of the present disclosure, including but not limited to a grabbing implement, a spraying implement, a planting implement, a harvesting implement, a pollinating implement, a marking implement, a blowing implement, or a depositing implement.

In some embodiments, an emitter is configured to direct a beam along an optical path, for example a laser path. In some embodiments, the beam comprises electromagnetic radiation, for example light, radio waves, microwaves, or x-rays. In some embodiments, the light is visible light, infrared light, or ultraviolet light. The beam may be coherent. In one embodiment, the emitter is a laser, such as an infrared laser.

One or more optical elements may be positioned in a path of the beam. The optical elements may comprise a beam combiner, a lens, a reflective element, or any other optical elements that may be configured to direct, focus, filter, or otherwise control light. The elements may be configured in the order of the beam combiner, followed by a first reflective element, followed by a second reflective element, in the direction of the beam path. In another example, one or both of the first reflective element or the second reflective element may be configured before the beam combiner, in order of the direction of the beam path. In another example, the optical elements may be configured in the order of the beam combiner, followed by the first reflective element in order of the direction of the beam path. In another example, one or both of the first reflective element or the second reflective element may be configured before the beam combiner, in the direction of the beam path. Any number of additional reflective elements may be positioned in the beam path.

The beam combiner may also be referred to as a beam combining element. In some embodiments, the beam combiner may be a zinc selenide (ZnSe), zinc sulfide (ZnS), or germanium (Ge) beam combiner. For example, the beam combiner may be configured to transmit infrared light and reflect visible light. In some embodiments, the beam combiner may be a dichroic beam combiner. In some embodiments, the beam combiner may be configured to pass electromagnetic radiation having a wavelength longer than a cutoff wavelength and reflect electromagnetic radiation having a wavelength shorter than the cutoff wavelength. In some embodiments, the beam combiner may be configured to pass electromagnetic radiation having a wavelength shorter than a cutoff wavelength and reflect electromagnetic radiation having a wavelength longer than the cutoff wavelength. In other embodiments, the beam combiner may be a polarizing beam splitter, a long pass filter, a short pass filter, or a band pass filter.

An optical control system of the present disclosure may further comprise a lens positioned in the optical path. In some embodiments, a lens may be a focusing lens positioned such that the focusing lens focuses the beam, the scattered light, or both. For example, a focusing lens may be positioned in the visible light path to focus the scattered light onto the targeting camera. In some embodiments, a lens may be a defocusing lens positioned such that the defocusing lens defocuses the beam, the scattered light, or both. In some embodiments, the lens may be a collimating lens positioned such that the collimating lens collimates the beam, the scattered light, or both. In some embodiments, two or more lenses may be positioned in the optical path. For example, two lenses may be positioned in the optical path in series to expand or narrow the beam.

The positions and orientations of one or both of the first reflective element and the second reflective element may be controlled by one or more actuators. In some embodiments, an actuator may be a motor, a solenoid, a galvanometer, or a servo. For example, the position of the first reflective element may be controlled by a first actuator, and the position and orientation of the second reflective element may be controlled by a second actuator. In some embodiments, a single reflective element may be controlled by a plurality of actuators. For example, the first reflective element may be controlled by a first actuator along a first axis and a second actuator along a second axis. Optionally, the mirror may be controlled by a first actuator, a second actuator, and a third actuator, providing multi-axis control of the mirror. In some embodiments, a single actuator may control a reflective element along one or more axes. In some embodiments, a single reflective element may be controlled by a single actuator.

An actuator may change a position of a reflective element by rotating the reflective element, thereby changing an angle of incidence of a beam encountering the reflective element. Changing the angle of incidence may cause a translation of the position at which the beam encounters the surface. In some embodiments, the angle of incidence may be adjusted such that the position at which the beam encounters the surface is maintained while the optical system moves with respect to the surface. In some embodiments, the first actuator rotates the first reflective element about a first rotational axis, thereby translating the position at which the beam encounters the surface along a first translational axis, and the second actuator rotates the second reflective element about a second rotational axis, thereby translating the position at which the beam encounters the surface along a second translational axis. In some embodiments, a first actuator and a second actuator rotate a first reflective element about a first rotational axis and a second rotational axis, thereby translating the position at which the beam encounters the surface of the first reflective element along a first translational axis and a second translational axis. For example, a single reflective element may be controlled by a first actuator and a second actuator, providing translation of the position at which the beam encounters the surface along a first translation axis and a second translation axis with a single reflective element controlled by two actuators. In another example, a single reflective element may be controlled by one, two, or three actuators.

The first translational axis and the second translational axis may be orthogonal. A coverage area on the surface may be defined by a maximum translation along the first translational axis and a maximum translation along the second translation axis. One or both of the first actuator and the second actuator may be servo-controlled, piezoelectric actuated, piezo inertial actuated, stepper motor-controlled, galvanometer-driven, linear actuator-controlled, or any combination thereof. One or both of the first reflective element and the second reflective element may be a mirror; for example, a dichroic mirror, or a dielectric mirror; a prism; a beam splitter; or any combination thereof. In some embodiments, one or both of the first reflective element and the second reflective element may be any element capable of deflecting the beam.

A targeting camera may be positioned to capture light, for example visible light, traveling along a visible light path in a direction opposite the beam path, for example laser path. The light may be scattered by a surface, such as the surface with an object of interest, or an object, such as an object of interest, and travel toward the targeting camera along visible light path. In some embodiments, the targeting camera is positioned such that it captures light reflected off of the beam combiner. In other embodiments, the targeting camera is positioned such that it captures light transmitted through the beam combiner. With the capture of such light, the targeting camera may be configured to image a target field of view on a surface. The targeting camera may be coupled to the beam combiner, or the targeting camera may be coupled to a support structure supporting the beam combiner. In one embodiment, the targeting camera does not move with respect to the beam combiner, such that the targeting camera maintains a fixed position relative to the beam combiner.

An optical control system of the present disclosure may further comprise an exit window positioned in the beam path. In some embodiments, the exit window may be the last optical element encountered by the beam prior to exiting the optical control system. The exit window may comprise a material that is substantially transparent to visible light, infrared light, ultraviolet light, or any combination thereof. For example, the exit window may comprise glass, quartz, fused silica, zinc selenide, zinc sulfide, a transparent polymer, or a combination thereof. In some embodiments, the exit window may comprise a scratch-resistant coating, such as a diamond coating. The exit window may prevent dust, debris, water, or any combination thereof from reaching the other optical elements of the optical control system. In some embodiments, the exit window may be part of a protective casing surrounding the optical control system.

After exiting the optical control system, the beam may be directed along beam path toward a surface. In some embodiments, the surface contains an object of interest, for example a weed. Rotational motions of reflective elements may produce a laser sweep along a first translational axis and a laser sweep along a second translational axis. The rotational motions of reflective elements may control the location at which the beam encounters the surface. For example, the rotation motions of reflective elements may move the location at which the beam encounters the surface to a position of an object of interest on the surface. In some embodiments, the beam is configured to damage the object of interest. For example, the beam may comprise electromagnetic radiation, and the beam may irradiate the object. In another example, the beam may comprise infrared light, and the beam may burn the object. In some embodiments, one or both of the reflective elements may be rotated such that the beam scans an area surrounding and including the object.

A prediction camera or prediction sensor may coordinate with an optical control system, such as optical control system, to identify and locate objects to target. The prediction camera may have a field of view that encompasses a coverage area of the optical control system covered by amiable laser sweeps. The prediction camera may be configured to capture an image or representation of a region that includes the coverage area to identify and select an object to target. The selected object may be assigned to the optical control system. In some embodiments, the prediction camera field of view and the coverage area of the optical control system may be temporally separated such that prediction camera field of view encompasses the target at a first time and the optical control system coverage area encompasses the target at a second time. Optionally, the prediction camera, the optical control system, or both may move with respect to the target between the first time and the second time.

In some embodiments, a plurality of optical control systems may be combined to increase a coverage area on a surface. The plurality of optical control systems may be configured such that the laser sweep along a translational axis of each optical control system overlaps with the laser sweep along the translational axis of the neighboring optical control system. The combined laser sweep defines a coverage area that may be reached by at least one beam of a plurality of beams from the plurality of optical control systems. One or more prediction cameras may be positioned such that a prediction camera field of view covered by the one or more prediction cameras fully encompasses the coverage area. In some embodiments, a detection system may comprise two or more prediction cameras, each having a field of view. The fields of view of the prediction cameras may be combined to form a prediction field of view that fully encompass the coverage area. In some embodiments, the prediction field of view does not fully encompass the coverage area at a single time point but may encompass the coverage area over two or more time points (e.g., image frames). Optionally, the prediction camera or cameras may move relative to the coverage area over the course of the two or more time points, enabling temporal coverage of the coverage area. The prediction camera or prediction sensor may be configured to capture an image or representation of a region that includes coverage area to identify and select an object to target. The selected object may be assigned to one of the plurality of optical control systems based on the location of the object and the area covered by laser sweeps of the individual optical control systems.

The plurality of optical control systems may be configured on a vehicle, such as vehicle 100 illustrated in FIG. 1-FIG. 3. For example, the vehicle may be a driverless vehicle. The driverless vehicle may be a robot. In some embodiments, the vehicle may be controlled by a human. For example, the vehicle may be driven by a human driver. In some embodiments, the vehicle may be coupled to a second vehicle being driven by a human driver, for example towed behind or pushed by the second vehicle. The vehicle may be controlled by a human remotely, for example by remote control. In some embodiments, the vehicle may be controlled remotely via longwave signals, optical signals, satellite, or any other remote communication method. The plurality of optical control systems may be configured on the vehicle such that the coverage area overlaps with a surface underneath, behind, in front of, or surrounding the vehicle.

The vehicle may be configured to navigate a surface containing a plurality of objects, including one or more objects of interest, for example a crop field containing a plurality of plants and one or more weeds. The vehicle may comprise one or more of a plurality of wheels, a power source, a motor, a prediction camera, or any combination thereof. In some embodiments, the vehicle has sufficient clearance above the surface to drive over a plant, for example a crop, without damaging the plant. In some embodiments, a space between an inside edge of a left wheel and an inside edge of a right wheel is wide enough to pass over a row of plants without damaging the plants. In some embodiments, a distance between an outside edge of a left wheel and an outside edge of a right wheel is narrow enough to allow the vehicle to pass between two rows of plants, for example two rows of crops, without damaging the plants. In one embodiment, the vehicle comprising the plurality of wheels, the plurality of optical control systems, and the prediction camera may navigate rows of crops and emit a beam of the plurality of beams toward a target, for example a weed, thereby burning or irradiating the weed.

### Point Detection

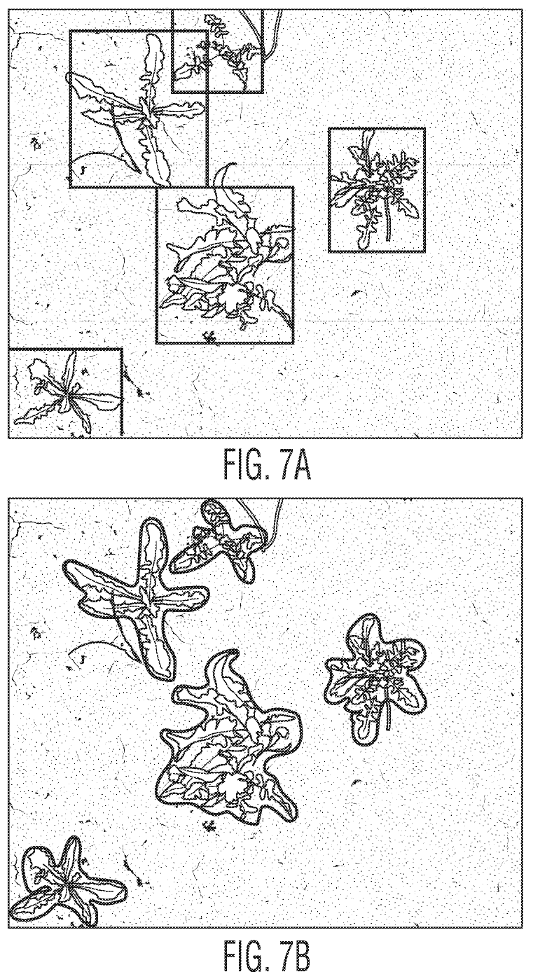

Described herein are point detection systems and methods for identifying and locating an object (e.g., plant, a pest, a piece of equipment, a surface irregularity, etc.) on a surface. These systems and methods may facilitate precise location of object features (e.g., an object center, an object center of mass, a plant meristem, a plant leaf, a pest thorax, etc.), which may be targeted for autonomous surface maintenance, such as weed eradication, pest management, crop maintenance, or soil maintenance. Point detection may comprise using point-based localization to identify and locate an object (e.g., a plant, a pest, a piece of equipment, a surface irregularity, etc.) within an image. In some embodiments, the point corresponds to a meristem of the plant. Point-based localization may provide an advantage over bounding region (FIG. 7A) or masking (FIG. 7B) based approaches by improving ease of object labeling and increasing localization and targeting precision.

Furthermore, the point detection methods described herein may be used to assess various object parameters in addition to object location. Parameters that may be assessed using the point detection methods described herein include, but are not limited to, object size (e.g., radius, diameter, surface area, or a combination thereof), plant maturity (e.g., age, growth stage, ripeness, crop yield, or a combination thereof), object category (e.g., weed, crop, equipment, pest, or surface irregularity), weed type (e.g., grass, broadleaf, purslane, or offshoot), crop type (e.g., onion, strawberry, carrot, corn, soybeans, barley, oats, wheat, alfalfa, cotton, hay, tobacco, rice, sorghum, tomato, potato, grape, rice, lettuce, bean, pea, sugar beet, etc.), pest type (e.g., spider, insect, fungus, ant, locust, worm, beetle, caterpillar, etc.), plant health (e.g., nutrition, disease state, or hydration), leaf shape, leaf arrangement (e.g., number of leaves or position of leaves), plant posture (e.g., standing, bent, or lying down), or a combination thereof.

A point detection model may be trained using training data comprising images of plants (e.g., images of weeds or images of crops) with labeled features. In some embodiments, an image of a plant may be labeled to indicate the center of the plant, the meristem of the plant, a leaf of the plant, a leaf outline, a radius of the plant, or combinations thereof.

### Machine Learning Models

A point detection method may be implemented by a point detection module configured to identify and locate objects in an image, for example a prediction image collected by a prediction sensor or a target image collected by a targeting sensor. In some embodiments, the point detection module may be part of or in communication with a prediction module. In some embodiments, the point detection module may be part of or in communication with a targeting module. The point detection module may implement one or more machine learning algorithms or networks that are implemented and dynamically trained to identify and locate objects within one or more images (e.g., a prediction image, a target image, etc.). The one or more machine learning algorithms or networks may include a neural network (e.g., convolutional neural network (CNN), deep neural network (DNN), etc.), geometric recognition algorithms, photometric recognition algorithms, principal component analysis using eigenvectors, linear discrimination analysis, You Only Look Once (YOLO) algorithms, hidden Markov modeling, multilinear subspace learning using tensor representation, neuronal motivated dynamic link matching, support vector machine (SVMs), or any other suitable machine learning technique. If the point detection module implements one or more neural networks for point detection, these one or more neural networks may include one or more convolutional layers, vision transformer layers, visual transformer layers, activation functions, pooling, batch normalization, other deep learning mechanisms, or a combination thereof. The point detection module may comprise a system controller, for example a system computer having storage, random access memory (RAM), a central processing unit (CPU), and a graphics processing unit (GPU). The system computer may comprise a tensor processing unit (TPU). The system computer should comprise sufficient RAM, storage space, CPU power, and GPU power to perform operations to identify and locate a plant.

The point detection machine learning model may be trained using a sample training dataset of images, such as high-resolution images, for example of surfaces with or without plants, pests, or other objects. The training images may be labeled with one or more object parameters, such as location (e.g., location of meristem, location of thorax, location of object center, leaf outline, etc.), object size (e.g., radius, diameter, surface area, or a combination thereof), plant maturity (e.g., age, growth stage, ripeness, crop yield, or a combination thereof), object category (e.g., weed, crop, equipment, pest, or surface irregularity), weed type (e.g., grass, broadleaf, or purslane), crop type (e.g., onion, strawberry, corn, soybeans, barley, oats, wheat, alfalfa, cotton, hay, tobacco, rice, sorghum, tomato, potato, grape, rice, lettuce, bean, pea, sugar beet, etc.), pest type (e.g., spider, insect, fungus, ant, locust, worm, beetle, caterpillar, etc.), plant health (e.g., nutrition, disease state, hydration, or a combination thereof), leaf shape, leaf arrangement (e.g., number of leaves or position of leaves), plant posture (e.g., standing, bent, or lying down), or combinations thereof. In some embodiments, the one or more machine learning algorithms implemented by the point detection module may be trained end-to-end (e.g., by training multiple parameters in combination). Alternatively, or in addition, subnetworks (e.g., point networks) may be trained independently. For instance, these subnetworks may be trained using supervised, unsupervised, reinforcement, or other such training techniques as described above.

An example of a model architecture for a point detection module is provided in FIG. 6. An image (e.g., an image collected by a prediction sensor or a targeting sensor) may be received by a backbone network. The network may be a CNN, including any number of nodes (e.g., neurons) organized in any number of layers, or the network may be built using vision transformers or visual transformers. In some embodiments, the convolutional neural network may comprise an input layer configured to receive the image, an identification layer configured to identify plants in the image, and an output layer configured to output data (e.g., feature maps, number of objects, locations of objects, or other parameters). Each layer of the convolutional neural network may be connected by any number of additional hidden layers. For example, a convolutional network may comprise of an input layer which receives an image, a series of hidden layers, and one or more output layers. Each of the hidden layers may perform a convolution over the image and output feature maps. The feature maps may be passed from the hidden layer to the next convolutional layer. The outputs layer may output a result of the network, such as an object size, a location within the image, object category (e.g., weed, crop, pest, equipment, or surface irregularity), and object type. In some embodiments, the output may be a multi-resolution output.

The backbone network may receive an image via an input layer. In some embodiments, the backbone may comprise a pre-trained network (e.g., ResNet50, MobileNet, CBNetV2, etc.) or a custom trained network. The backbone may comprise a series of convolution layers, activation functions, pooling, batch normalization, vision transformers, visual transformers, other deep learning mechanisms, or combinations thereof that may be organized into residual blocks. The backbone network may process, as input, an image (e.g., a prediction image, a target image, etc.) to produce an output that may be fed into the rest of the machine learning network. For example, the output may comprise one or more feature maps comprising features of the input image via an output layer.

An output of the backbone network (e.g., a feature map) may be received by one or more additional networks or layers configured to identify one or more parameters, such as the presence of objects, number of objects, object location, object size, object type, plant maturity, plant category, weed type, crop type, plant health, or combinations thereof. In some embodiments, a network or layer may be configured to evaluate a single parameter. In some embodiments, a network or layer may be configured to evaluate two or more parameters. In some embodiments, the parameters may be evaluated by a single network or layer. The output of a network or layer may include a grid comprising one or more cells. A cell of the grid may represent an object (e.g., a plant, a pest, a piece of equipment, or a surface irregularity). The cell may further comprise parameters of the object, such as object location, object size, plant maturity, plant category, weed type, crop type, plant health, or combinations thereof. In some embodiments, the location of the object may be expressed as an offset relative to an anchor point (e.g., relative to a corner of the grid cell). It should be noted that while grids and cells are described and illustrated extensively throughout the present disclosure according to the Cartesian coordinate system, these grids and cells may be defined using other coordinate systems (e.g., polar coordinates, etc.).

In some examples, an output of the backbone network (e.g., a feature map) may be received by an Atrous Spatial Pyramid Pooling (ASPP) layer. The ASPP layer may apply a series of atrous convolutions to the output of the backbone network. In some embodiments, the outputs of the atrous convolutions may be pooled and provided to a subsequent network layer of the point detection model.

The point detection model may further comprise one or more networks configured to predict parameters of the object and relating to the points. The point networks may receive an output from the backbone network or the ASPP layer. Examples of networks that may be implemented to predict the parameters of an object and relating to the points may include a point hits network, a point category network, a point offset network, and a point size network. In some instances, the functionality of the aforementioned networks may be combined such that a single network may be implemented to predict the parameters of an object.

In an embodiment, a point hit network may be implemented to generate a grid of predictions with a output slice for each hit class. In some instances, a grid cell may be designated as containing a hit (i.e., containing an object). As an illustrative, but not limiting, example, a hit class may correspond to whether the object is a weed, crop, pest, or other class of defined object. In some instances, a grid cell may be designating as containing no hit (i.e., not containing an object). Another example of a hit class may include an infrastructure class, which may correspond to whether the object includes a drip tape or other watering mechanism. The point hit network may comprise a series of one or more CNNs running in parallel, each of which may contain a series of convolutional layers, activation functions, batch normalization functions, skip connections, pooling or other deep learning mechanisms (e.g., vision or visual transformers), or combinations thereof. The output of the point hit network may comprise an output slice for each hit class (e.g., weed, crop, equipment, pest, or surface irregularity). For example, the point hit network may comprise a first output slice corresponding to a weed category and a second output slice corresponding to a crop category. In some embodiments, an activation function (e.g., a sigmoid activation function, a softmax activation function, a step activation function, linear activation function, hyperbolic tangent activation function, Rectified Linear Unit (ReLU) activation function, swish activation function, etc.) may be applied to the output of the point hit network. The output of the point hit network may comprise a set of predictions, optionally configured as a grid, with an output slice for each hit category (e.g., weed, crop, equipment, pest, or surface irregularity).

A point category network may be included to determine an object category or type for any objects present in the image. The point category network may comprise a series of one or more CNNs running in parallel, each of which may contain a series of convolutional layers, activation functions, batch normalization functions, skip connections, as well as pooling or other deep learning mechanisms (e.g., vision transformers, visual transformers, etc.), or combinations thereof. The output of the point category network may comprise an output slice for each object category or type. For example, for a plant classification (e.g., weed or crop), the point category network may determine the specific type of plant corresponding to the identified plant classification (e.g., grass, broadleaf, purslane, offshoot, onion, strawberry, carrot, corn, soybeans, barley, oats, wheat, alfalfa, cotton, hay, tobacco, rice, sorghum, tomato, potato, grape, rice, lettuce, bean, pea, sugar beet, etc.). The point category network, for this example, may comprise a first output slice corresponding to a grass type, a second output slice corresponding to a broadleaf type, a third output slice corresponding to a purslane type, and so on. In some embodiments, an activation function (e.g., a sigmoid activation function, a softmax activation function, a step activation function, linear activation function, hyperbolic tangent activation function, ReLU activation function, swish activation function, etc.) may be applied to the output of the point category network. The output of the point category network may comprise a set of predictions, optionally configured as a grid, with an output slice for each hit category or type (e.g., grass, broadleaf, purslane, offshoot, onion, strawberry, carrot, corn, soybeans, barley, oats, wheat, alfalfa, cotton, hay, tobacco, rice, sorghum, tomato, potato, grape, rice, lettuce, bean, pea, sugar beet, spider, ant, locust, worm, beetle, caterpillar, fungus, rock, etc.).

The point detection model may further comprise a point offset network, which may be included to determine point locations of objects present in the image. The point offset network may comprise a series of one or more CNNs running in parallel, each of which may contain a series of convolutional layers, activation functions, batch normalization functions, skip connections, as well as pooling or other deep learning mechanisms (e.g., vision transformers, visual transformers, etc.), or combinations thereof. The output of the point offset network may comprise an output slice for each coordinate dimension of each object category (e.g., x coordinate output slice and a y coordinate output slice for each of a crop category, a weed category, a pest category, an equipment category, a surface irregularity category, or combinations thereof). For example, the point offset network may comprise a first output slice corresponding to x coordinates of a weed category, a second output slice corresponding to y coordinates of a weed category, a third output slice corresponding to x coordinates of a crop category, and a fourth output slice corresponding toy coordinates of a crop category. In some embodiments, an activation function (e.g., a sigmoid activation function, a softmax activation function, a step activation function, linear activation function, hyperbolic tangent activation function, ReLU activation function, swish activation function, etc.) may be applied to the output of the point offset network. The output of the point offset network may comprise a set of predictions, optionally configured as a grid, with an output slice for each coordinate dimension and category type, as described above. In some embodiments, point locations may be expressed as Cartesian coordinates (e.g., x, y, and/or z coordinates) relative to a reference point in the image (e.g., an edge of the image, a center of the image, or a grid line within the image). In some embodiments, point locations may be expressed as polar, spherical, or cylindrical coordinates (e.g., θ, r, and/or φ (spherical) or z (cylindrical) coordinates) relative to a reference point in the image (e.g., an edge of the image, a center of the image, or a polar grid line within the image).

The point detection model may further comprise a point size network, which may be included to determine a size of objects present in the image. The point size network may comprise a series of one or more CNNs running in parallel, each of which may contain a series of convolutional layers, activation functions, batch normalization functions, skip connections, as well as pooling or other deep learning mechanisms (e.g., vision transformers, visual transformers, etc.), or combinations thereof. The output of the point size network may comprise an output slice for each hit class, corresponding to a size of the item at the grid square (in the case of a rectangular grid) with the hit class (e.g., weed size, crop size, equipment size, pest size, or surface irregularity size). For example, the point size network may comprise a first output slice corresponding to a weed size and a second output slice corresponding to a crop size. In some embodiments, an activation function (e.g., a sigmoid activation function, a softmax activation function, a step activation function, linear activation function, hyperbolic tangent activation function, ReLU activation function, swish activation function, etc.) may be applied to the output of the point hits network. Optionally, the output may be scaled, such as using a multiplier or exponential modifier. The output of the point size network may comprise a set of predictions, optionally configured as a grid, with an output slice for each hit category (e.g., weed size, crop size, equipment size, pest size, or surface irregularity size).

Point network predictions (e.g., category predictions from a point hit network, type or class predictions from a point category network, location predictions from a point offset network, size predictions from a point size network, or combinations thereof) may be further processed to reduce error (e.g., remove false positives, remove points in error-prone image regions, and/or remove duplicates). For example, predictions for objects located within border regions of an image (e.g., within a pre-determined distance from an edge of the image) may be discarded to remove objects that may not fall completely within the image. Alternatively, or in addition, non-maximum suppression may be applied to the output points to remove duplicate predictions within the same region of the image.

The parameters determined by the point detection module may be provided to one or more systems configured to locate, track, target, or evaluate the identified plants. For example, a location of a plant meristem may be provided to a targeting system to target the plant with an implement (e.g., a laser) at the location of the plant meristem. In some embodiments, the location of the plant meristem may be a predicted location. In some embodiments, the location of the plant meristem may be a target location. In another example, parameters (e.g., plant size, plant type, or a combination thereof) may be provided to an activation time module configured to determine an implement activation time (e.g., a laser activation time) based on the provided parameters. In some embodiments, the parameters provided to a system may be separated based on one or more parameters. For example, parameters of weeds may be provided to a targeting module for weed eradication, and parameters of crops may not be provided to the targeting module.

A machine learning model (e.g., a machine learning component of a point detection module or a prediction module) may be fine-tuned to update the model with additional training examples (e.g., additional training images). The fine-tuning process may be used to improve model performance without fully re-training the model, thereby reducing overall training time without compromising model performance. A machine learning model trained as described herein (e.g., using a standard number of training images, batches, and epochs) may be fine-tuned to incorporate additional examples. The trained model may be used as the parent or base model for the fine-tuning process. For example, the weights determined for the trained model may be used as the starting point for updating the model with additional examples. The additional examples may be combined with the examples used to train the parent model to form a training dataset. The examples may be denoted as “old” (e.g., images used to train the parent model) or “new” (e.g., additional images not used to train the parent model). Training batches may be formed using examples randomly selected from the training dataset with a pre-determined ratio of old examples and new examples per batch. For example, each batch may contain 50% old examples and 50% new examples, or each batch may contain 70% old examples and 30% new examples. In some embodiments, the ratio of old and new data for each batch may be selected based on the amount of data in each category, the similarity of the data between the two categories, or other parameter. By using batches containing a mix of old and new examples, the model may be updated using fewer batches, fewer epochs, or fewer batches and fewer epochs than if the model were fully re-trained. Additionally, by using a mix of old and new examples, performance of the model on the old examples may be retained while improving performance on the new examples.

In some embodiments, a machine learning model (e.g., a machine learning component of a point detection module or a prediction module) may undergo a pretraining step prior to training. Performing a pretraining step may improve model performance, reduce training time, or both. Pretraining may be performed using a large, combined dataset of examples sharing a common feature (e.g., images of plants). For example, the combined dataset may include images of weeds or images of crops, which share the common feature of being images of plants. The pretraining may use a larger number of epochs than full model training (e.g., 80 epochs instead of 40 epochs) and a larger number of examples than full model training (e.g., 15,000 images instead of 7,500 images). The pretraining process may be used to determine weights that better reflect the model data than generic starting weights (e.g., ResNet50, MobileNet, or CBNetV2 starting weights). The weights determined from pretraining may be used as a starting point for full model training. For example, pretraining may determine starting weights that better represent plant image data, and the weights determined from pretraining may be used as starting weights for training models to identify specific types or categories of plants (e.g., weeds, crops, types of weeds, or types of crops) or to distinguish certain types or categories of plants (e.g., to distinguish weeds from onions or weeds from carrots). A pretrained model may then be used as starting point for full model training on a subset of the pretraining data specific to the full model. The full model training may improve specialized performance compared to the pretrained model. For example, a fully trained model may have improved performance to distinguish weeds from other plants, as compared to the pretrained model trained to identify unspecified plants. In some embodiments, the same pretrained model may be used to train multiple specialized models. For example, the same pretrained model may be used to train specialized models to identify weeds within a type of crops. For example, a specialized model may be trained to identify weeds within a field of onions. In another example, a specialized model may be trained to identify weeds within a field of carrots.

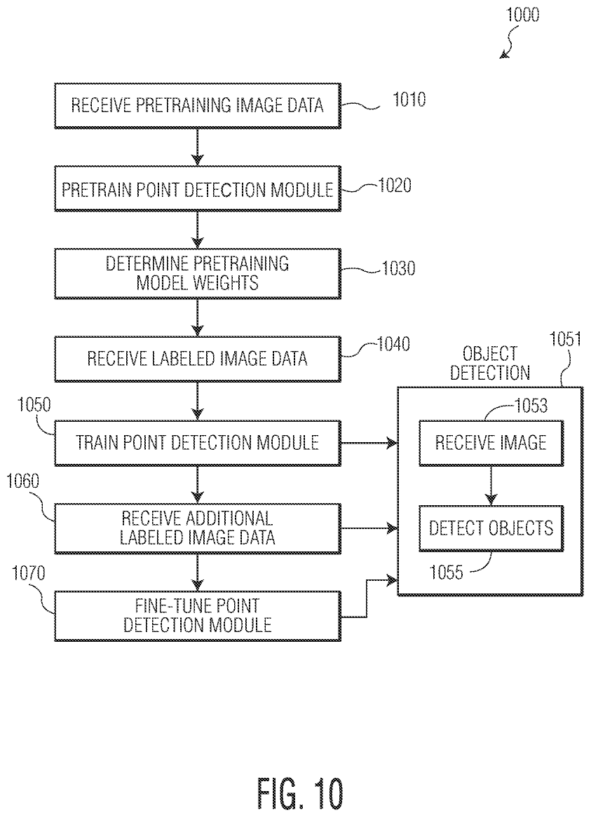

FIG. 10 provides an example of a method 1000 by which a point detection module may be trained and fine-tuned using the methods described herein. At step 1010, an untrained network may receive pretraining image data. The pretraining image data may comprise a combined dataset of images sharing a common feature, such as images of plants. The pretraining image data may include labeled image data from multiple training datasets, such as labeled image data from a weed training set and labeled image data from a crop training set. The point detection module may be pretrained at step 1020 using the pretraining image data. Pretraining model weights may be determined at step 1030 based on the pretraining. The pretrained model weights may be more representative of an image dataset (e.g., a weed image dataset, a crop image dataset, a farm image dataset, a region image dataset, a company image dataset, a weed image dataset, or a species image dataset) than weights from the untrained model. The pretrained point detection module may receive labeled image data at step 1040, corresponding to a dataset of interest. For example, the labeled image data may comprise labeled image data from a weed training set (e.g., labeled images of purslane weeds in a field of crops, labeled images of broadleaf weeds in a field of crops, labeled images of offshoots in a field of crops, or labeled images of grasses in a field of crops). In another example, the labeled image data may comprise labeled image data from a crop training set (e.g., images of onion fields with labeled onions and weeds, images of strawberry fields with labeled strawberries and weeds, images of carrot fields with labeled carrots and weeds, images of corn fields with labeled corn plants and weeds, images of soybean fields with labeled soybeans and weeds, images of barley fields with labeled barley plants and weeds, images of oat fields with labeled oats and weeds, images of wheat fields with labeled wheat plants and weeds, images of alfalfa fields with labeled alfalfa plants and weeds, images of cotton fields with labeled cotton plants and weeds, images of hay fields with labeled hay plants and weeds, images of tobacco fields with labeled tobacco plants and weeds, images of rice fields with labeled rice plants and weeds, images of sorghum fields with labeled sorghum plants and weeds, images of tomato fields with labeled tomatoes and weeds, images of potato fields with labeled potatoes and weeds, images of grape fields with labeled grapes and weeds, images of lettuce fields with labeled lettuce plants and weeds, images of bean fields with labeled beans and weeds, images of pea fields with labeled peas and weeds, or images of sugar beet fields with labeled sugar beets and weeds). In another example, the labeled image data may comprise labeled image data from a farm training set (e.g., images of fields on a certain farm with labeled crops and weeds). In another example, the labeled image data may comprise labeled image data from a region training set (e.g., images of fields in a certain agricultural region with labeled crops and weeds). The point detection module may be trained at step 1050 to identify object parameters (e.g., location, size, category, or type) for objects of interest (e.g., plants, weeds, a type of weed, crops, or a type of crop). Before, after, or between steps of process 1000, or concurrently with process 1000, the point detection module training process (e.g., after any of steps 1050, 1060, or 1070), the trained, partially trained, or fine-tuned point detection module may be used to detect objects 1051 to identify object parameters (e.g., location, size, category, or type) for objects of interest by receiving an image at step 1053, such as an image of the ground containing one or more objects. The point detection module (e.g., the trained, partially trained, or fine-tuned point detection module resulting from steps 1050, 1060, or 1070) may be used for object detection 1051. In some embodiments, object detection 1051 may be performed by a prediction system (e.g., prediction system 400 in FIG. 11) to execute point detection. Objects may be detected in the image at step 1055. Upon receiving additional labeled image data at step 1060, such as new images of objects of interest (e.g., new images of plants, weeds, a type of weed, crops, or a type of crop), the point detection module may be pre-trained at step 1020, trained at step 1050, or fine-tuned at step 1070.

In some embodiments, labeled image data, such as the labeled image data received and step 1040 or the additional labeled image data received at step 1060, may be obtained from images received at step 1053. Images received at step 1053 may be labeled and used for point detection model training or fine-tuning. In some embodiments, object detection performed at step 1055 may be used to determine which images are further labeled and used for training or fine-tuning.

### Implement Activation

One or more parameters of a target object (e.g., a target plant) evaluated by a point detection system may be used to determine implement activation (e.g., whether to activate the implement, where on the object to activate the implement, or duration of activation). In some embodiments, activation may be determined by an activation module based on one or more parameters. For example, whether to activate the implement may be based on an object category (e.g., weed or crop). In another example, location of activation on the object (e.g., which part of the object to target with the implement) may be determined based on an object shape (e.g., location of centroid, meristem location, leaf shape, or leaf position) or object posture (e.g., standing, bent, or lying down). In another example, implement activation time may be determined based on object category (e.g., broadleaf, offshoot, purslane, or grass), object size (e.g., small, medium, or large), or a combination thereof. The activation module may be part of a a prediction module, a location prediction module, a scheduling module, a targeting module, a targeting control module, or combinations thereof. An implement (e.g., a laser) of a targeting module, controlled by a targeting control module, may target the plant at the location of the plant meristem for an amount of time determined by the activation module. The activation time may be a time sufficient to manipulate (e.g., kill) the target plant. Targeting the plant meristem with the implement may facilitate precise targeting of meristematic cells. For example, irradiating the meristematic cells of a plant with an infrared laser implement may burn the meristematic cells, thereby killing the plant. In addition to meristem location, additional parameters may be provided to the activation module to determine the activation time.

In one example, plant size, plant type, or both may be provided to the activation module and used to determine activation time of a laser implement configured to irradiate and burn target plants. Larger plants or certain plant types may be more resistant to burning and may require longer irradiation to kill the plant. Provided in TABLE 1 are examples of type factor multipliers that may be applied to an activation time to account for resistance of different plant types.

TABLE 1
Examples of Type Factor Multipliers for Laser Activation Times

| Plant Type | Type Factor |
|---|---|
| Broadleaf | 1.0 |
| Offshoot | 1.1 |
| Purslane | 1.2 |
| Grass | 1.5 |

In some embodiments, an additional multiplier may be applied to an activation time to account for non-linear scaling of activation times with plant size. Examples of size factor multipliers are provided in TABLE 2.

TABLE 2
Examples of Size Factor Multipliers for Laser Activation Times

| Size Category | Size Range | Size Factor |
|---|---|---|
| Small | <10 mm | 1.0 |
| Medium | 10 mm-25 mm | 1.1 |
| Large | >25 mm | 1.3 |

As example, an activation time sufficient to kill a plant may be determined as follows:

activation time(ms)=r(time factor)(type factor)(size factor)+base time

where r is a plant size. The time factor may account for system parameters or external conditions, such as laser intensity, temperature, altitude, or other factors. The type factor may account for differences in kill times between different weed types. The size factor may account for non-linear scaling of kill times with weed size, for example as shown in TABLE 2. The base time may be a minimum activation time and may be adjusted to account for system parameters or external conditions.

In some embodiments, a time multiplier may be about 50 ms. In some embodiments, a time multiplier may be about 10 ms, about 20 ms, about 30 ms, about 40 ms, about 50 ms, about 60 ms, about 70 ms, about 80 ms, about 90 ms, or about 100 ms. In some embodiments, a time multiplier may be from about 10 ms to about 100 ms, from about 20 ms to about 80 ms, from about 30 ms to about 70 ms, or from about 40 ms to about 60 ms. In some embodiments, a base time may be about 50 ms. In some embodiments, a base time may be about 10 ms, about 20 ms, about 30 ms, about 40 ms, about 50 ms, about 60 ms, about 70 ms, about 80 ms, about 90 ms, or about 100 ms. In some embodiments, a base time may be from about 10 ms to about 100 ms, from about 20 ms to about 80 ms, from about 30 ms to about 70 ms, or from about 40 ms to about 60 ms. In some embodiments, an activation time may be from about 100 ms to about 10,000 ms, from about 100 ms to about 5,000 ms, from about 100 ms to about 2,000 ms, or from about 200 ms to about 2,000 ms.

In another example, an activation time sufficient to kill a plant may be determined using a machine learning model. The machine learning model may be trained using a dataset of observed activation times sufficient to kill plants with a variety of characteristics. For example, activation times may be measured for plants of various sizes and types, and the observed activation times may be used to train a machine learning model. For instance, as the point detection system is used to exterminate a plant or otherwise remove an object using the laser, the point detection system may record the activation time for the laser and, in some instances, additional record image data that may be used to determine whether the plant or other object has been successfully removed. This data may be evaluated by a user or other entity to determine whether the activation time used for a particular plant or object was sufficient to successfully remove the plant or other object. Based on this evaluation, the dataset of observed activation times may be updated and used to iteratively train the machine learning model. For instance, if an activation time for the laser is deemed insufficient for exterminating a particular type of plant having a particular size, the machine learning model may be updated such that for plants of a similar type and size, the activation time may be automatically increased to ensure that these plants are exterminated or otherwise removed successfully. Alternatively, if an activation time for the laser is deemed sufficient for exterminating a particular type of plant having a particular size, the machine learning model may be reinforced such that this activation time may be used for plants of a similar type and size. Thus, as the point detection system is used to exterminate plants or otherwise remove objects using the laser, the machine learning model may be continuously, and iteratively, updated in order to accurately identify an appropriate activation time for different plants and objects.

Activation time may be used to determine whether to target an object. As described herein, a scheduling module may select objects identified by a prediction system and schedule the objects to be targeted by a targeting system. In some embodiments, a scheduling module may prioritize targeting objects with short activation times over objects with longer activation times. For example, a scheduling module may schedule four weeds with shorter activation times to be targeted ahead of one weed with a longer activation time, such that more weeds may be targeted and killed in the available time.

In some embodiments, implement activation may be based on a confidence score for an object. Confidence scores may quantify the confidence with which an object has been identified, classified, located, or combinations thereof. For example, a confidence score may quantify the certainty that a plant is classified as a weed. In another example, a confidence score may quantify a certainty for classifying a plant as each of a broadleaf, a purslane, an offshoot, or a grass. In some embodiments, a confidence score may quantify the certainty that an object is not a particular class or type. For example, a confidence score may quantify the certainty that an object is not a crop and may be used to determine whether to shoot the crop with a laser. A confidence score may be assigned to each identified object in each collected image for each evaluated parameter (e.g., one or more of object location, weed classification, crop classification, purslane weed type, broadleaf weed type, offshoot weed type, grass weed type, onion crop type, strawberry crop type, carrot crop type, corn crop type, or soybeans crop type). A confidence score may be used to determine how long to activate the implement. For example, an object identified with high confidence as a large grass may be targeted with a laser for longer than an object identified with high confidence as a small broadleaf.

In some embodiments, a confidence score may range from zero to one, with zero corresponding to low confidence and one corresponding to high confidence. The threshold for values considered to be high confidence may depend on the situation and may be tuned based on a desired outcome. In some embodiments, a high confidence value may be considered greater than or equal to 0.5, greater than or equal to 0.6, greater than or equal to 0.7, greater than or equal to 0.8, or greater than or equal to 0.9. In some embodiments, a low confidence value may be considered less than 0.3, less than 0.4, less than 0.5, less than 0.6, less than 0.7, or less than 0.8. An object with a higher confidence score for a first object type and lower confidence scores for other object types may be identified as the first object type. For example, an object that has a confidence score of 0.6 for broadleaf type, a confidence score of 0.1 for purslane type, a confidence score of 0.2 for offshoot type, and a confidence score of 0.1 for grass type may be identified as a broadleaf weed.

A confidence score may be used to determine whether to activate an implement at an object by evaluating a level of confidence that an object has a parameter selected for targeting with the implement. For example, a confidence score may be used to determine whether to shoot an object with a laser by evaluating a level of confidence that the object is a weed. In some embodiments, determining whether to target an object with the implement may comprise evaluating confidence scores over time (e.g., determining confidence scores for multiple observations of an object over a series of image frames). An object may be targeted if multiple high confidence observations are made. An object may not be targeted if a single high confidence observation and multiple low confidence or ambiguous observations are made. For example, an object may be targeted if it has weed confidence scores over four image frames of 0.9, 0.8, 0.8, and 0.8. In another example, an object may be targeted if it has weed confidence scores over four image frames of 0.9, 0.7, 0.5, and 0.8. In another example, an object may not be targeted if it has weed confidence scores of over four image frames of 0.4, 0.5, 0.8, and 0.4. Threshold values for confidence values, number of observations, or both may be used to determine whether to target the object. Threshold values may depend on the situation and may be tuned based on a desired outcome. In some embodiments, threshold values for confidence values or number of observations may be determined based on the number of opportunities for observation. For example, a threshold for the number of observations may be determined based on the number of frames the object is predicted to be in a camera field of view. In some embodiments, threshold values may be determined experimentally.

### Computer Systems and Methods

The detection and targeting methods described herein may be implemented using a computer system. In some embodiments, the detection systems described herein include a computer system. In some embodiments, a computer system may implement the object identification and targeting methods autonomously without human input. In some embodiments, a computer system may implement the object identification and targeting methods based on instructions provided by a human user through a detection terminal.

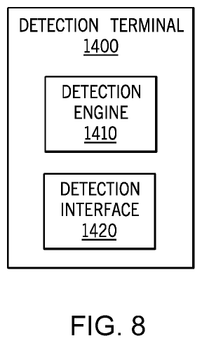

FIG. 8 illustrates components in a block diagram of a non-limiting exemplary embodiment of a detection terminal 1400 according to various aspects of the present disclosure. In some embodiments, the detection terminal 1400 is a device that displays a user interface in order to provide access to the detection system. As shown, the detection terminal 1400 includes a detection interface 1420. The detection interface 1420 allows the detection terminal 1400 to communicate with a detection system. In some embodiments, the detection interface 1420 may include an antenna configured to communicate with the detection system, for example by remote control. In some embodiments, the detection terminal 1400 may also include a local communication interface, such as an Ethernet interface, a Wi-Fi interface, or other interface that allows other devices associated with detection system to connect to the detection system via the detection terminal 1400. For example, a detection terminal may be a handheld device, such as a mobile phone, running a graphical interface that enables a user to operate or monitor the detection system remotely over Bluetooth, Wi-Fi, or mobile network.

The detection terminal 1400 further includes detection engine 1410. The detection engine may receive information regarding the status of a detection system. The detection engine may receive information regarding the number of objects identified, the identity of objects identified, the location of objects identified, the trajectories and predicted locations of objects identified, the number of objects targeted, the identity of objects targeted, the location of objects targeted, the location of the detection system, the elapsed time of a task performed by the detection system, an area covered by the detection system, a battery charge of the detection system, or combinations thereof.

Actual embodiments of the illustrated devices will have more components included therein which are known to one of ordinary skill in the art. For example, each of the illustrated devices will have a power source, one or more processors, computer-readable media for storing computer-executable instructions, and so on. These additional components are not illustrated herein for the sake of clarity.

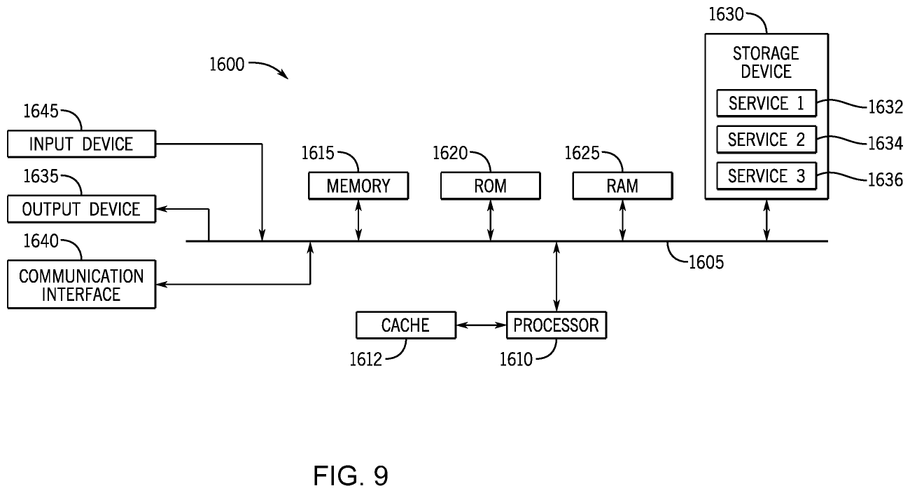

In some examples, the procedures described herein (e.g., the procedure of FIG. 6, or other procedures described herein) may be performed by a computing device or apparatus, such as a computing device having the computing device architecture 1600 shown in FIG. 9. In one example, the procedures described herein can be performed by a computing device with the computing device architecture 1600. The computing device can include any suitable device, such as a mobile device (e.g., a mobile phone), a desktop computing device, a tablet computing device, a wearable device, a server (e.g., in a software as a service (SaaS) system or other server-based system), and/or any other computing device with the resource capabilities to perform the processes described herein, including the procedure of FIG. 6. In some cases, the computing device or apparatus may include various components, such as one or more input devices, one or more output devices, one or more processors, one or more microprocessors, one or more microcomputers, and/or other component that is configured to carry out the steps of processes described herein. In some examples, the computing device may include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

A procedure is illustrated in FIG. 6, the operation of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 illustrates an example computing device architecture 1600 of an example computing device which can implement the various techniques described herein. For example, the computing device architecture 1600 can implement procedures shown in FIG. 6, or control the vehicles shown in FIG. 1 and FIG. 2. The components of computing device architecture 1600 are shown in electrical communication with each other using connection 1605, such as a bus. The example computing device architecture 1600 includes a processing unit (which may include a CPU and/or GPU) 1610 and computing device connection 1605 that couples various computing device components including computing device memory 1615, such as read only memory (ROM) 1620 and random-access memory (RAM) 1625, to processor 1610. In some embodiments, a computing device may comprise a hardware accelerator.

Computing device architecture 1600 can include a cache of high-speed memory connected directly with, in close proximity to, or integrated as part of processor 1610. Computing device architecture 1600 can copy data from memory 1615 and/or the storage device 1630 to cache 1612 for quick access by processor 1610. In this way, the cache can provide a performance boost that avoids processor 1610 delays while waiting for data. These and other modules can control or be configured to control processor 1610 to perform various actions. Other computing device memory 1615 may be available for use as well. Memory 1615 can include multiple different types of memory with different performance characteristics. Processor 1610 can include any general-purpose processor and a hardware or software service, such as service 1 1632, service 2 1634, and service 3 1636 stored in storage device 1630, configured to control processor 1610 as well as a special-purpose processor where software instructions are incorporated into the processor design. Processor 1610 may be a self-contained system, containing multiple cores or processors, a bus, memory controller, cache, etc. A multi-core processor may be symmetric or asymmetric.

To enable user interaction with the computing device architecture 1610, input device 1645 can represent any number of input mechanisms, such as a microphone for speech, a touch-sensitive screen for gesture or graphical input, keyboard, mouse, motion input, speech and so forth. Output device 1635 can also be one or more of a number of output mechanisms known to those of skill in the art, such as a display, projector, television, speaker device, etc. In some instances, multimodal computing devices can enable a user to provide multiple types of input to communicate with computing device architecture 1600. Communication interface 1640 can generally govern and manage the user input and computing device output. There is no restriction on operating on any particular hardware arrangement and therefore the basic features here may easily be substituted for improved hardware or firmware arrangements as they are developed.

Storage device 1630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1625, read only memory (ROM) 1620, and hybrids thereof. Storage device 1630 can include services 1632, 1634, 1636 for controlling processor 1610. Other hardware or software modules are contemplated. Storage device 1630 can be connected to the computing device connection 1605. In one aspect, a hardware module that performs a particular function can include the software component stored in a computer-readable medium in connection with the necessary hardware components, such as processor 1610, connection 1605, output device 1635, and so forth, to carry out the function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

While illustrative embodiments have been illustrated and described, it will be appreciated that various changes can be made therein without departing from the spirit and scope of the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

As used herein, the terms “about” and “approximately,” in reference to a number, is used herein to include numbers that fall within a range of 10%, 5%, or 1% in either direction (greater than or less than) the number unless otherwise stated or otherwise evident from the context (except where such number would exceed 100% of a possible value).

### EXAMPLES

The invention is further illustrated by the following non-limiting examples.

### Example 1

### Eradication of Weeds in a Field of Crops

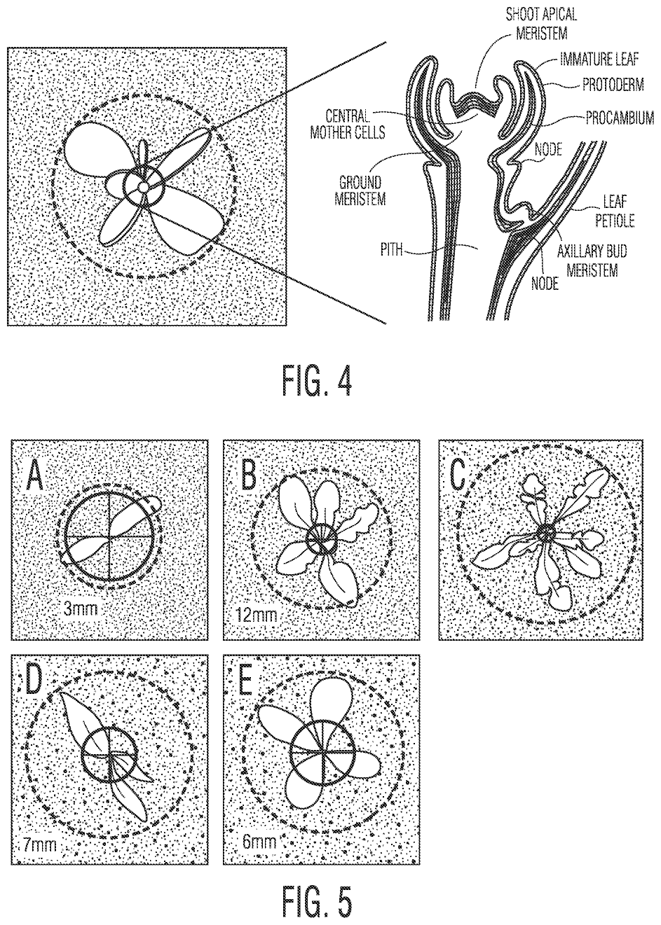

This example describes eradication of weeds in a field of crops using the detection methods of the present disclosure. A vehicle, as illustrated in FIG. 1 and FIG. 3, equipped with a prediction system, a targeting system, and an infrared laser was positioned in a field of crops, as illustrated in FIG. 2. The vehicle navigated the rows of crops at a speed of about 2 miles per hour, and a prediction camera collected images of the field. The prediction system identified weeds within the images and determined parameters of the weed including leaf radius, as indicated by the broken circle in FIG. 4, and weed type. The prediction system determined a predicted location of the weed corresponding to the location of the weed meristem, as indicated by the solid circle and central point in FIG. 4. The prediction system sent the predicted location to the targeting system.

The targeting system was selected based on availability and proximity to the selected weed. The targeting system included a targeting camera and infrared laser, the directions of which were adjusted by mirrors controlled by actuators. The mirrors reflected the visible light from the surface to the targeting camera and reflected the infrared light from the laser to the surface. The targeting system converted the predicted location received from the prediction system to actuator positions. The targeting system adjusted the actuators to point the targeting camera and infrared laser beam toward the predicted position of the selected weed. The targeting camera imaged the field at the predicted position of the weed and the location was revised to produce a target location. The targeting system adjusted the position of the targeting camera and infrared laser beam based on the target location of the weed and activated the infrared beam directed toward the location of the weed. The beam irradiated the weed with infrared light for an amount of time based on the weed parameters, killing the weed.

### Example 2

### Determining Laser Activation Time from Weed Parameters

This example describes determining a laser activation time sufficient to kill a weed based on parameters of the weed. A weed was identified in an image, and parameters of the weed were determined. Parameters include leaf radius and weed type. Laser activation time, in milliseconds (ms), was determined as follows:

activation time(ms)=r(time factor)(type factor)(size factor)+base time

where r is the leaf radius in millimeters (mm), measured from meristem to farthest leaf tip. The time factor is a multiplier that may be adjusted to account for system parameters or external conditions, such as laser intensity, temperature, altitude, or other factors. The type factor is a multiplier that accounts for differences in kill times between different weed types. The size factor is a size multiplier that accounts for non-linear scaling of kill times with weed size; a different size factor is applied for leaf radii falling within small, medium, or large size categories, and the multiplier increases as the size category increases. The base time is a minimum activation time, in milliseconds (ms), that is applied to each weed; in this example the base time is 50 ms, but the base time may be adjusted to account for system parameters or external conditions.

TABLE 3 provides examples of weed parameters, multipliers, and activation times for the weeds show in FIG. 5. Weed meristems are marked with solid circles with crosshairs, and leaf radii are indicated by broken circles.

TABLE 3
Examples of Weed Parameters and Laser Activation Times

| | Leaf | Time | | Type | Size | Size | Base | Activation |
|---|---|---|---|---|---|---|---|---|
| Weed | Radius | Multiplier | Type | Factor | Category | Factor | Time | Time |
| A | 3 mm | 50 ms | Purslane | 1.2 | Small | 1.0 mm⁻¹ | 50 ms | 230 ms |
| B | 12 mm | 50 ms | Broadleaf | 1.0 | Medium | 1.1 mm⁻¹ | 50 ms | 710 ms |
| C | 30 mm | 50 ms | Broadleaf | 1.0 | Large | 1.3 mm⁻¹ | 50 ms | 2000 ms |
| D | 7 mm | 50 ms | Grass | 1.5 | Small | 1.0 mm⁻¹ | 50 ms | 575 ms |
| E | 6 mm | 50 ms | Purslane | 1.2 | Small | 1.0 mm⁻¹ | 50 ms | 410 ms |

The determined laser activation time was provided to a targeting system including an infrared laser. The infrared laser was aimed at the weed meristem, and the laser was activated for the determined length of time. The activation time was sufficient to burn the plant meristem, thereby killing the weed.

### Example 3

### Point Detection Model Architecture

This example describes a model architecture of a point detection system used to identify and locate weeds. An image of a ground surface is collected with a prediction camera and passed to a backbone network, as illustrated in FIG. 6. The backbone network is a convolutional neural network, or a network built on vision transformers. The output of the backbone network is a set of feature maps, which are fed into a series of additional networks used to determine plant parameters. For example, the additional networks include a point hits network to identify plant hits and distinguish hits as plants or crops, a point category network to determine the type of weed or crop, a point size network to determine the size of the weed or the crop, and a point offset network to determine the location of the weed or the crop.

Each of the additional networks, including the point hits network, the point category network, the point size network, and the point offset network, produces a grid in which each cell of the grid can represent a plant from which parameters (e.g., weed or crop, plant type, plant size, or plant offset/location) are determined.

### Example 4

### Selecting and Scheduling Weeds to be Targeted

This example describes selecting and scheduling weeds to be targeted for eradication. Objects are detected in images collected by a prediction camera of an autonomous weed eradication system. The location of each object is determined, and confidence scores are assigned for plant categories and plant types, including a crop confidence score and a weed confidence score. The confidence scores for an object may be based on a single image or multiple images. Objects with weed confidence scores above a target threshold, crop confidence scores below a target threshold, or both are identified as weeds. Objects with crop confidence scores above a target threshold, weed confidence scores below a target threshold, or both are identified as crops. For objects identified as weeds, additional parameters are determined including weed type, confidence values for each weed type, weed size, and activation time.

Objects identified as weeds are scheduled for eradication based on parameters including weed location, plant and weed confidence scores, and eradication time. To ensure that weeds and not crops are being targeted, objects with higher weed confidence scores and/or lower plant confidence scores are scheduled for eradication with higher priority, while objects with lower weed confidence scores and/or higher plant confidence scores are scheduled for eradication with lower priority. In order to eradicate as many weeds as possible during an available time, weeds with shorter activation times are scheduled with higher priority for eradication than weeds with longer activation times.

While preferred embodiments of the present invention have been shown and described herein, it will be apparent to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-74. (canceled)

75. A computer-implemented method to detect a target plant, the computer-implemented method comprising:
receiving an image of a region of a surface, the region comprising the target plant positioned on the surface;
determining one or more parameters of the target plant, wherein the one or more parameters includes a point location of the target plant; and
identifying the target plant in the image based on the one or more parameters using a trained classifier.

76. The computer-implemented method of claim 75, wherein the point location corresponds to a feature of the target plant.

77. The computer-implemented method of claim 76, further comprising using the trained classifier to locate the feature of the target plant.

78. The computer-implemented method of claim 76, wherein the feature is a center of the target plant, a meristem of the target plant, or a leaf of the target plant.

79. The computer-implemented method of claim 75, wherein the one or more parameters further comprise a plant location, a plant size, a plant category, a plant type, a leaf shape, a leaf arrangement, a plant posture, a plant health, or combinations thereof.

80. The computer-implemented method of claim 75, further comprising targeting the target plant with an implement at the point location.

81. The computer-implemented method of claim 80, wherein the implement is a laser, a sprayer, or a grabber.

82. The computer-implemented method of claim 80, further comprising activating the implement for a duration of time at the point location.

83. The computer-implemented method of claim 82, wherein the duration of time is sufficient to kill the target plant.

84. The computer-implemented method of claim 82, wherein the duration of time is based a parameter of the one or more parameters of the target plant.

85. The computer-implemented method of claim 82, wherein the duration of time scales non-linearly with a plant size of the target plant.

86. The computer-implemented method of claim 80, comprising killing the target plant with the implement.

87. The computer-implemented method of claim 80, comprising burning the target plant at the point location using the implement.

88. The computer-implemented method of claim 75, further comprising classifying a plant type of the target plant.

89. The computer-implemented method of claim 88, wherein the plant type is based on a leaf shape of the target plant.

90. The computer-implemented method of claim 88, wherein the plant type is selected from the group consisting of a crop, a weed, a grass, a broadleaf, a purslane, or combinations thereof.

91. The computer-implemented method of claim 75, further comprising assessing a condition of the target plant.

92. The computer-implemented method of claim 91, wherein the condition comprises health, maturity, nutrition state, disease state, ripeness, crop yield, or any combination thereof.

93. The computer-implemented method of claim 75, further comprising determining a confidence score for the one or more parameters.

94. The computer-implemented method of claim 93, further comprising scheduling the target plant to be targeted based on the confidence score.

95. The computer-implemented method of claim 75, wherein the trained classifier is trained using a training data set comprising labeled images.

96. The computer-implemented method of claim 95, wherein the labeled images are labeled with plant category, meristem location, plant size, plant condition, plant type, or any combination thereof.

97. A computer-implemented method to detect a target object, the computer-implemented method comprising:
receiving an image of a region of a surface, the region comprising a target object positioned on the surface;
obtaining labeled image data comprising parameterized objects corresponding to similarly positioned objects;
training a machine learning model to identify object parameters corresponding to target objects, wherein the machine learning model is trained using the labeled image data;
generating an object prediction corresponding to one or more parameters of the target object, wherein the one or more object parameters of the target object includes a point location of the target object, and wherein the one or more object parameters are identified by using the image as input to the machine learning model;
identifying the target object in the image based on the one or more parameters; and
updating the machine learning model using the image, the one or more parameters, and information corresponding to identification of the target object, wherein when the machine learning model is updated, the machine learning model is used to identify new object parameters from new images.

98. The computer-implemented method of claim 97, wherein the target object is a target plant, a pest, a surface irregularity, or a piece of equipment.

99. The computer-implemented method of claim 97, wherein the surface is a dirt surface, a floor, a wall, a lawn, a road, a mound, a pile, or a pit, an agricultural surface, a construction surface, a mining surface, an uneven surface, or a textured surface.

100. The computer-implemented method of claim 97, further comprising using a trained classifier to identify the target object.

101. The computer-implemented method of claim 97, further comprising using a trained classifier to locate a feature of the target object, wherein the trained classifier is trained using a training data set comprising labeled images.

102. The computer-implemented method of claim 97, wherein updating the machine learning model comprises receiving additional labeled image data comprising the image and fine-tuning the machine learning model based on the additional labeled image data.

103. The computer-implemented method of claim 102, wherein fine-tuning the machine learning model is performed with an image batch comprising a subset of the additional labeled image data and a subset of the labeled image data.

104. The computer-implemented method of claim 102, wherein fine-tuning the machine learning model is performed using fewer batches, fewer epochs, or fewer batches and fewer epochs than training the machine learning model.

105. The computer-implemented method of claim 97, further comprising pretraining the machine learning model.

106. The computer-implemented method of claim 105, wherein pretraining the machine learning model is performed with a pretraining dataset comprising the labeled image data and pretraining labeled image data sharing a common feature of the labeled image data.
